(19) United States
(12) Patent Application Publication
(10) Pub. No.: US 2004/0181436 A1
(43) Pub. Date: Sep. 16, 2004

(54) Method and system of charitable fundraising and socially responsible investment involving life insurance products

(76) Inventor: Jeffrey Lange, New York, NY (US)

Correspondence Address: KENYON & KENYON, ONE BROADWAY, NEW YORK, NY, 10004, US

(21) Appl. No.: 10/692,219

(22) Filed: Oct. 22, 2003

Related U.S. Application Data
(63) Continuation-in-part of application No. 10/389,335, filed on Mar. 14, 2003.

(51) Int. Cl. G06F 17/60

(52) U.S. Cl. 705/4

(57) ABSTRACT

This invention enables donations to nonprofits, such as universities and colleges, at minimal or no cost to the donors. A nonprofit holds life insurance policies on the lives of consenting donors. The nonprofit assigns the death benefits of the policies to a financial benefactor and acquires an ownership interest in the financial benefactor, entitling the nonprofit to a portion of periodic payments by the financial benefactor from assets of the financial benefactor. The assets include the cash value of the policies and annuities purchased by the financial benefactor with invested funds or purchased by equity partners to the nonprofit, providing annuity payments for the measured lives of the donors. Portions of the periodic payments are distributed to the nonprofit and to the investors. Remaining portions of the periodic payments can cover premium payments, or be distributed to other investors providing other invested funds, e.g., from debt financing, to cover the premium payments.

### RELATED APPLICATIONS

This application is a continuation-in-part of U.S. application Ser. No. 10/389,355, filed on Mar. 14, 2003, which is incorporated by reference in its entirety into this application.

### FIELD OF THE INVENTION

The present invention relates generally to systems, methods, plans and products for charitable fundraising using life insurance products such as life insurance policies and annuities. The present invention generates substantial fundraising for nonprofit institutions or entities at no or minimal cost to the benefactors or donors of such entities, while providing a return to investors or financial partners supporting the enablement of such donations. The investors invest in a partnership or limited liability corporation that finances the life insurance policies and purchases the annuities. The insured annuities, in turn, provide an economic return to the investors in the financial partnership or corporation, funds for the charitable entities, and funding to maintain the life insurance policies or provide payment or an economic return to the investors whose capital is used to maintain the life insurance policies.

### BACKGROUND OF THE INVENTION

A number of uses for life insurance products have emerged in recent years to fulfill a dual investment and future liability funding purpose. One prominent example is Corporate Owned Life Insurance (COLI) plans, in which a corporation purchases life insurance on its employees. The corporation pays all premiums for the life insurance and receives the bulk of the death benefits. Under the Internal Revenue Code Section 101(a)(1), the death benefit proceeds received by the corporation are tax free. Because of the tax free nature of the death benefits, the rate of return earned on the premiums paid to purchase the insurance is typically attractive to the corporation on an after-tax basis. The returns from COLI (and related plans, such as Bank Owned Life Insurance or BOLI) are often used to fund future compensation and benefit liabilities of the corporation. In many cases, COLI returns are used to fund so called nonqualified retirement plans, which provide pension, health, and other retirement benefits to former employees of the corporation. These benefits are more easily defined, funded and administered using a COLI plan as compared to traditional methods of funding qualified benefit programs.

Even more recently, nonprofit institutions such as churches, foundations, and charities have become interested in using the unique features of life insurance to fund future liabilities and operations. In developing planned giving programs, such nonprofit institutions, also referred to as charitable organizations, have employed life insurance policies and annuity contracts. For example, it is a common practice for nonprofit institutions to solicit the owner of a life insurance policy to name the nonprofit entity as the policy's beneficiary. The owner pays the premiums on the policy and, at the time of the insured's death the nonprofit institution receives the death benefit. Another common practice involving life insurance policies is for the owner of the policy to donate both the ownership and beneficial interest in the policy to the charity along with a pledge to remit future premium payments to the charity so that the policy can be maintained in force.

Charitable giving involving annuity contracts, which typically pay level periodic payments as long as the annuitant is alive, is also commonplace. An owner of an annuity, for example, can designate the charity as the annuity payee whereby the charity will receive periodic payments until the death of the life measured by the annuity contract. In yet another common permutation, a donor will make a lump sum transfer to a charity in exchange for periodic payments while the donor, or some other person, is alive. In this scenario, the charity will offer periodic payments which are lower than those offered by insurance companies and thereby benefit from the difference between the rate it offers the donor and the higher rate offered by the insurance company from which the charity commonly purchases the annuity with the donated funds. Such arrangements are typically called charitable gift annuities.

A life insurance policy typically has three distinct categories of parties which have an interest in the contract: the owners, the insureds, and the beneficiaries. The owner is the party which is responsible for maintaining the policy in force by remitting premium payments to the insurance company. The insured is the person upon whose death the policy death benefit is paid. The beneficiary is the party which receives the death benefit upon the death of the insured. A holder of a life insurance policy may refer to, for example, a purchaser or an owner of the contract, or a beneficiary under the policy, or a combination of two or more of the above. Under a typical life insurance policy, the insured individual is the holder of the policy, because (s)he has purchased the policy, is the policy owner and beneficiary. However, there is no requirement that the owner, insured, or beneficiary be the same person, as described in further detail below. The holder of the policy may then just refer to the owner, or the entity who purchased the policy. For example, the owner of a policy may legally donate the policy to a charity which insures the life of his wife and which names his son as beneficiary.¹ In making the donation, the donor will typically name the charity as beneficiary and then transfer ownership status of the policy. However, in order for the donation to have enduring value, the policy must be kept in force. The donor and former owner, therefore, must make a commitment for paying future premium payments. ¹ Most states have adopted laws under which charities may own, purchase, or be named beneficiary of life insurance policies on consenting individuals. These laws directly confer an insurable interest upon the charity and allow the elimination of the administratively burdensome step of requiring the donor to first purchase a new policy and then donate it to the charity.

Charitable institutions have developed programs known as ROLI (for Religious Owned Life Insurance), FOLI (for Foundation Owned Life Insurance), and CHOLI (for Charity Owned Life Insurance). These programs have involved the enlisting of past or future donors or benefactors for the purpose of purchasing insurance on a pool of such donors or benefactors. The nonprofit entity usually borrows the money to pay for the insurance premiums from a bank (or possibly the insurance company itself), and receives death benefits when its donors die. The death benefits are then used to repay the loans from the bank or the insurance company. The balance of the death benefits, if any, is used to fund the nonprofit entities' primary objectives, such as finding research, furthering religious programs, or disbursing benefits to the needy.

A number of problems with respect to systems and methods for purchasing life insurance to fund nonprofit institutions have emerged and remain unaddressed. The first problem is legal and regulatory. Most state insurance codes have a number of laws which address the requirement of an “insurable interest” in the context of life insurance. As a general matter, the owner of a policy is required to have an insurable interest, meaning that there must be some relationship between the owner of the policy and the insured in which the owner would suffer some form of loss should the insured die. In many cases, state law does not require that the beneficiary of a life insurance policy have an insurable interest. For example, California Insurance Code section 10110.1(b) states that “[a]n individual has an unlimited insurable interest in his or her own life . . . and may lawfully take out a policy of insurance on his or her own life . . . and have the policy made payable to whomsoever he or she pleases, regardless of whether the beneficiary designated has an insurable interest.”

Some states, however, have additional statutory law that restricts the purchase of a policy in other situations. For example, the New York Insurance Laws, section 3205(b)(2) states that “No person shall procure or cause to be procured, directly or by assignment or otherwise any contract of insurance upon the person of another unless the benefits under such contract are payable to the person insured or his personal representatives, or to a person having, at the time when such contract is made, an insurable interest in the person insured.” Such states have carved out exceptions for nonprofit institutions. For example New York Insurance Laws section 3205(b)(3) provides a safe harbor for nonprofit entities which “procure or cause to be procured, directly or by assignment or otherwise, a contract of life insurance upon the person of another and may designate itself or cause to have itself designated as the beneficiary of such contract.”

Despite such exceptions and safe harbor provisions, CHOLI and other nonprofit insurance owned programs have encountered significant problems. First, the tax free nature of the investment returns to nonprofits is not material since these institutions are not subject to income tax. The investment returns for nonprofits from owning or otherwise holding beneficial interests in insurance policies on benefactors must be attractive on a nominal, i.e., pre-tax basis. While this is possible, most, if not all charities, which have implemented CHOLI programs have used lenders to provide the funds to purchase the policies. The cost of the funds to the charities can reduce substantially, if not all, of the investment returns to such programs, depending upon the cost of lender funds, the nature of the policies underwritten, and, of course, the mortality experience of the benefactors insured. Second, the charities which have to date employed CHOLI programs do not have any efficient means for selecting an underwriting program of benefactors to achieve superior investment returns on a nominal basis. Such different means would include (i) having access to a well-defined class of insureds with higher mortality risk who happen to be benefactors; (2) underwriting these benefactors with the preferred life insurance products; and (3) financing the underwriting of the insurance efficiently. Third, state insurance regulators have so far frowned upon the existing CHOLI programs which rely upon private for-profit outside lenders to provide the funding to purchase the life insurance on the benefactors. For example, in May 2002, Michigan regulators denied approval to a plan with such outside investors stating that the investors “do not have an insurable interest but an investment interest.” (“Dying to Donate: Charities Invest in Death Benefits,” The Wall Street Journal, Feb. 6, 2003).

With respect to nonprofit universities, colleges and other nonprofit educational institutions which have significant fundraising needs and programs, use of insurance products to effectively increase donations or enhance investment returns has been problematic. First, such fundraising programs have not targeted a defined underwriting class of benefactors, such as, for example, an alumni cohort of a specific age and graduating year, i.e., factors directly related to mortality risk. Second, existing uses of life insurance policy products for donation purposes have been hampered to the extent that traditional gifting techniques have been relied upon. For example, universities and colleges have solicited donors to buy life insurance policies and either transfer ownership of them or seek to be named as beneficiaries in the policies. Obviously, this requires the donor to purchase the policy and maintain premium payments over the life of the policy, which is a costly undertaking. Third, existing uses of annuity products have also been less than satisfactory. For example, the college or university will seek to have a donor purchase an annuity which pays the donor an income while he is alive with a large death benefit payable to the college or university upon death. The main difficulty with these types of arrangements involving annuities which provide for both donor life income and a benefit to a beneficiary upon death is that large upfront premium payments by donors are usually required.

Other existing problems for nonprofit entities' or profit entities' funding using life insurance products include, but are not limited to:

1) State insurable interest rules: As indicated, most states have insurable interest rules applicable to nonprofit owners and beneficiaries of donor life insurance. Some of the potential problems with insurable interest include:

(a) If the policy is found to have violated the insurable interest rules when issued, the issuing insurance company can later argue that the policy was void from the beginning and will not pay the death benefit at the insured's death. While nonprofit or charitable institutions are assumed to have an insurable interest in the life of a donor in most states, there may be unusual provisions in the state code which must be followed exactly in order to avoid having the contract nullified later. For example, if a nonprofit located in New York purchases a policy on the life of a donor residing in California, the insurable interest rules under New York law (the location of the policy owner) must be met.

(b) If the beneficiary or donor purchases a policy but the ownership is immediately transferred to another party, the insurance company may later attempt to void the contract if the insurable interest rules for either owner are in any way not met.

(c) In some cases where the insurance purchase did not meet state insurable interest laws, the IRS has denied income, gift, and estate tax charitable deductions.

2) Nonprofit fiduciary duties: A beneficiary which is a nonprofit or charitable institution will have fiduciary restrictions regarding the type of assets that it may invest in. For most charities, investing in or originating life insurance on donors may not be considered suitable investments under their existing investment mandates.

3) Capital Constraints: Most nonprofits will not have the capital to fund the required premiums for originated life insurance on donors. Presumably, this capital would need to be raised from other donors which greatly impedes the efficiency of using life insurance as a means of funding nonprofit entities. Furthermore, as already indicated, nonprofit institutions which raise money from outside lenders or investors may run afoul of state insurance codes or insurance regulations requiring those receiving life insurance death benefits to have an insurable interest (e.g., New York Insurance Code Section 3502(a)(2)).

### SUMMARY OF THE INVENTION

To solve these and other problems with respect to general nonprofit owned insurance plans and generating insurance-based funding for beneficiaries that can be for-profit or nonprofit entities or individuals, and for the purpose of providing a plan applicable to such beneficiaries, the present invention provides methods and systems and a plan and product utilizing life insurance products for simultaneously (1) generating large sums of contributions to beneficiary individuals or nonprofit entities; (2) providing no-cost incentives to individual benefactors or donors of such entities, such as alumni of a university or college, to make such contributions; (3) funding or financing the purchase of life insurance and annuities on the lives of the benefactors; (4) optimizing the returns on the funding or financing net of donated life insurance and annuity proceeds to the nonprofit entities; and (5) complying with state insurance law and regulations related to insurable interest requirements for nonprofit entities or other beneficiaries.

Some of the advantageous aspects of the present invention may include the ability to generate excess risk adjusted returns for endowment investment funds, create substantial amounts of life insurance and current annuity payment gifts to the nonprofit entities or other beneficiaries at no cost to the donor, and provide methods for the efficient implementation of the program for optimizing investment fund returns, creating maximum donations to beneficiaries, such as the nonprofit entities, and providing means to maximize participation by individual benefactors, all while satisfying state legal and regulatory requirements.

One feature of the present invention is to provide efficient methods and systems for enabling or facilitating the donation of life insurance proceeds to nonprofit entities. In particular, a feature of the present invention is to provide superior means for universities, colleges, and other educational institutions with substantial endowments to both enhance the rate of return on endowment assets and also dramatically increase the amount of donor gifts through life insurance.

A need is recognized for methods and systems to both enhance the returns of university and college endowment funds without undue risk taking while also simultaneously increasing the amount of donor life insurance benefits earmarked for such institutions.

A need is recognized for methods and systems which simultaneously solicit donor interest in providing life insurance death benefits to the colleges and universities of their choice while also simultaneously financing the purchase of such life insurance policies using funds from the endowments of the colleges and universities in such a manner which is not inconsistent with state insurance laws or regulations.

A need is also recognized to both finance and underwrite a select group of alumni of such colleges and universities such that the pool of insurance policies owned by the endowments which provide the funding for the policies obtain risk adjusted excess returns on the capital used to pay the policy premiums.

A need is also recognized to guarantee a stream of current annual cashflows to nonprofit entities such as colleges and universities whereby such a stream of annual cashflows is facilitated by endowments or other investors which provide the funding for the simultaneous purchase of a life insurance policy and a single premium immediate annuity with life only payment of cashflows.

According to one embodiment of the present invention, as described herein, a method, system and plan for using life insurance products to achieve a simultaneous increase in donor life insurance gifts to universities and colleges and optimized excess returns on university and college endowment investment funds, comprises the steps of:

1) determining the required return on investment by the endowment investment funds;

2) selecting from among a database of prospective donor alumni of the universities and colleges a defined pool of insured donors based upon their age, health status, net worth, donative desire and intent, and other characteristics;

3) creating irrevocable life insurance trusts for each such selected donor;

4) appointing a trustee or trustees for such life insurance trusts

5) obtaining investment capital from the respective nonprofit endowment investment fund of the colleges and universities;

6) underwriting universal, variable universal, whole, term or other life insurance policies on each selected donor;

7) selecting the optimal policy to be underwritten from a variety of issuing insurers based upon the planned premium, guaranteed premium, length of guarantee, interest crediting rate, lapse rate subsidies, and other variables relevant to the overall economic performance of the policy in terms of the expected internal rate of return on the future death benefit;

8) using the capital obtained from the endowment investment funds to finance the initial premium payments and subsequent premiums, where necessary, on the selected donor policies;

9) splitting the insurance policy death benefits between the university or college and the endowment investment fund by naming both as beneficiaries of the irrevocable life insurance trust; and

10) optimizing the returns to the endowment investment funds versus the life insurance donations received by the university or colleges by allocating various percentages of the death benefit to be paid to the endowments investment funds or the university or college.

In an additional embodiment, a method for enabling donations of life insurance proceeds to a first entity is described, including the steps of: holding a life insurance policy on at least one donor in trust; financing the life insurance policy with funds from a second entity separate from the first entity; and establishing a distribution of proceeds from the life insurance policy to the first entity and the second entity.

In another additional embodiment, a method for enabling donations of life insurance proceeds to a nonprofit entity is described, including the steps of: holding, for each of at least one donor, a life insurance policy on the donor in a trust; financing the life insurance policy with funds from a nonprofit fund, the nonprofit fund being separate from the nonprofit entity; and establishing a distribution of proceeds from the life insurance policy to the nonprofit entity and the nonprofit fund.

In another additional embodiment, a method for enabling donations of life insurance proceeds by a donor to a nonprofit entity or similar beneficiary is described, including the steps of: purchasing an annuity with a loan; securing the loan with a first portion of proceeds from the life insurance policy; financing the loan and the life insurance policy with the annuity; and allocating a second portion of the proceeds from either the life insurance policy or the annuity or both to a beneficiary or nonprofit entity.

In another additional embodiment, a method for enabling donations of life insurance proceeds by a donor to a beneficiary, includes the steps of: supplying annuity payments to a life insurance trust, the life insurance trust holding a life insurance policy on a donor in trust and a loan on a death benefit of the life insurance policy, the life insurance trust using the annuity payments to finance the loan and the life insurance policy on the donor, a first portion of the death benefit being allocated to the loan and a second portion of the death benefit being allocated to the beneficiary; and receiving a lump sum consideration from the life insurance trust for the annuity payments equal to a principal amount of the loan.

In another additional embodiment, a method for enabling donations of life insurance proceeds by a donor to a beneficiary is described, including the steps of: determining a principal amount for a loan to a life insurance trust on a life insurance policy on the donor held by the life insurance trust, as a function of a death benefit of the life insurance policy; and defining a portion of the death benefit of the life insurance policy as collateral for the loan, to be allocated to the loan upon a death of the donor, another portion of the death benefit to be allocated to the beneficiary.

In another additional embodiment, a method for enabling donations of life insurance proceeds by a donor to a beneficiary, includes the step of insuring annuity payments purchased by a life insurance trust for a life of a donor with a loan secured by a first portion of a death benefit from a life insurance policy on the donor held by the life insurance trust in trust, the annuity payments financing the loan and the life insurance policy. In this embodiment, a second portion of the death benefit is allocated to a beneficiary upon death of the donor.

In another additional embodiment, a method for enabling donations of life insurance proceeds by a donor to a beneficiary is described, including the step of: investing in a lending entity that provides a loan to a life insurance trust collateralized with assets held by the life insurance trust, the assets including a first portion of proceeds on a life insurance policy on a donor held by the life insurance trust in trust, a second portion of the proceeds on the life insurance policy being designated as a donation to the beneficiary upon death of the donor; and investing in a reinsurance entity that provides insurance to an annuity paying entity on annuity payments supplied by the annuity paying entity to the life insurance trust for the life of the donor, the annuity payments financing the loan and the life insurance policy.

In another additional embodiment, a method for enabling donations of life insurance proceeds by a donor to a beneficiary is described, including the step of: investing in a lending entity that provides a loan to a life insurance trust for a purchase of an annuity, the loan being collateralized with assets held by the life insurance trust, the assets including a first portion of proceeds on a life insurance policy on a donor held by the life insurance trust in trust, a second portion of the proceeds on the life insurance policy being designated as a donation to the beneficiary upon death of the donor. The annuity payments from the annuity finance the loan and the life insurance policy.

In another additional embodiment, a method for enabling donations of life insurance proceeds by a donor to a beneficiary is described, including the step of: investing in a reinsurance entity that provides insurance to an annuity paying entity on annuity payments purchased by a life insurance trust for a lifetime of a donor, the life insurance trust purchasing the annuity payments with a loan taken by the life insurance trust, the loan being secured with a life insurance policy on the donor held by the life insurance trust in trust, the annuity payments financing the loan and the life insurance policy.

In another additional embodiment, a system enabling donations of life insurance proceeds to a nonprofit entity is described, including a life insurance trust holding a life insurance policy on a life of a donor in trust, and a nonprofit fund separate from the nonprofit entity, the nonprofit find providing funds to the life insurance trust for financing the life insurance policy. The life insurance trust establishes a distribution of proceeds from the life insurance policy to the nonprofit entity and the nonprofit fund.

In another additional embodiment, a system enabling donations of life insurance proceeds to a nonprofit entity is described, including a life insurance trust holding in trust at least one life insurance policy on each of at least one donor to the nonprofit entity, and a nonprofit fund separate from the nonprofit entity. The nonprofit fund provides funds to the life insurance trust for financing each life insurance policy on each donor. The life insurance trust establishes a distribution of proceeds from each life insurance policy to the nonprofit entity and the nonprofit fund.

In another additional embodiment, a system enabling donations of life insurance proceeds to a nonprofit entity is described, including a life insurance policy on a life of a donor, the life insurance policy being held in trust by a life insurance trust, and financed by the life insurance trust with funds provided to the life insurance trust from a nonprofit fund separate from the nonprofit entity. Proceeds from the life insurance policy are distributed by the life insurance trust to the nonprofit entity and the nonprofit fund.

In another additional embodiment, an investment vehicle in a nonprofit investment fund supporting life insurance donations to a nonprofit entity is described, the investment vehicle includes a tradable instrument providing investment capital to the nonprofit investment fund, the nonprofit investment fund being separate from the nonprofit entity, funds from the nonprofit investment fund being provided to a life insurance trust to finance a life insurance policy on a life of a donor. The life insurance trust holds the life insurance policy in trust and establishes a distribution of proceeds from the life insurance policy to the nonprofit investment fund and the nonprofit entity.

In another additional embodiment, a system enabling donations of life insurance proceeds to a beneficiary is described, including: a life insurance policy on a life of a donor, the life insurance policy being held in trust by a life insurance trust; a loan taken by the life insurance trust collateralized with the life insurance policy; and an annuity purchased by the life insurance trust with a principal amount of the loan, annuity payments from the annuity financing the loan and the life insurance policy. A first portion of a death benefit of the life insurance policy is allocated for the loan, and a second portion of the death benefit is allocated for donation to the beneficiary.

In another additional embodiment, an investment vehicle in an investment fund supporting life insurance donations to beneficiaries is described, the investment vehicle includes a tradable instrument providing investment capital to an investment fund, the investment fund investing the investment capital in a lending entity and a reinsurance entity. The lending entity provides a loan to a life insurance trust collateralized with a life insurance policy on a donor. The loan is provided for the life insurance trust to purchase annuity payments from an annuity paying entity. The life insurance policy is held by the life insurance trust in trust. A first portion of a death benefit of the life insurance policy is designated as collateral for the loan and a second portion of the death benefit is designated as a donation to a beneficiary. The reinsurance entity provides insurance to the annuity paying entity on the annuity payments purchased by the life insurance trust from the annuity paying entity. The annuity payments finance the loan and the life insurance policy.

In another additional embodiment, a debt investment vehicle to enable life insurance donations to beneficiaries is described, the debt investment vehicle including a loan to a borrower for a purchase of an annuity on a lifetime of a donor. The loan is secured by a life insurance policy on a donor. The life insurance policy is held by the borrower in a trust. The annuity finances the loan and the life insurance policy. A first portion of a death benefit of the life insurance policy is allocated to repay the loan, and a second portion of the death benefit is allocated for donation to a beneficiary.

In another additional embodiment, a system enabling life insurance donations to beneficiaries is described, the system including insurance on an annuity providing annuity payments to a life insurance trust for a life of a donor. The annuity is purchased by the life insurance trust with a loan on a life insurance policy on the life of the donor. The life insurance trust holds the life insurance policy in trust. The annuity payments cover interest on the loan and premiums on the life insurance policy. A first portion of a death benefit of the life insurance policy is assigned as collateral for the loan, and a second portion of the death benefit is allocated as a donation to a beneficiary.

In another additional embodiment, a system enabling donations of life insurance proceeds to a beneficiary is described, including: a life insurance trust holding a life insurance policy on a life of a donor in trust; a lending entity providing a loan to the life insurance trust on the life insurance policy; and an annuity paying entity providing annuity payments to the life insurance trust for the life of the donor in exchange for a principal amount of the loan. A first portion of a death benefit of the life insurance policy is assigned as collateral for the loan, and a second portion of the death benefit is allocated as a donation to a beneficiary. The annuity payments cover interest payments on the loan and premiums on the life insurance policy.

In another additional embodiment, a method for enabling donations of life insurance proceeds by a donor to a beneficiary is described, including the steps of: purchasing an annuity with a loan; securing the loan with a life insurance policy; financing the loan and the life insurance policy with the annuity; allocating a first portion of proceeds of the life insurance policy to repay the loan; and allocating a second portion of the proceeds of the life insurance policy to the beneficiary.

In another additional embodiment, a method for financing an annuity on a lifetime of a donor is described, including the steps of: offering a loan for purchasing the annuity, with requirements including a requirement that the loan be collateralized with a life insurance policy on the donor, and another requirement that the annuity be used to finance the loan and the life insurance policy, e.g., by covering interest payments on the loan and premiums on the life insurance policy.

According to another additional embodiment, the method and system of fundraising for charities and nonprofit institutions of the present invention involving life insurance products will draw its support from a network of benefactors. The benefactors will typically be divided into two classes although benefactors may overlap: insured benefactors are those who consent to have a nonprofit entity purchase or own a life insurance policy on their lives. They also additionally provide consent, either to the nonprofit or to a partnership in which the nonprofit is a partner, to the purchase of a single premium immediate annuity (typically with life only payout) on their lives.

Investors provide the financing to purchase the annuity, typically to the partnership in which the nonprofit has a partnership interest, along with the investors. The investor is the financial benefactor through the partnership. The partnership is the financial benefactor to the nonprofit. As described above, the person responsible for paying the premium or consideration for a life insurance policy or annuity contract need not be the same person or entity which owns the contract, and, furthermore, a still different entity may be the beneficiary of the contract. The nonprofit institution may rely upon its benefactors to be the insureds for the life insurance and annuity contracts (the “insured benefactors”). These benefactors are typically very interested in a making a planned gift to the nonprofit entity, but might have considerable difficulty in committing to making a large upfront annuity payment or significant life insurance premium payments for an extended period. Accordingly, the nonprofit will typically solicit the donation of a life insurance policy from an insured benefactor on the life of the insured benefactor. The nonprofit entity, will, however, not ask the insured benefactor to make a pledge to keep the policy in force by making premium payments, but will instead look to its base of financial benefactors to maintain the policy through premium payments.

These investors will provide the finds to maintain the insurance policy and to purchase an annuity on the life of the insured benefactor who has donated the life insurance policy. The invested finds used to maintain the life insurance policy may arise from debt financing and the invested funds used to purchase the annuity may arise from equity financing. Alternatively, the invested funds can be used to purchase the annuity, and the annuity will make distributions sufficient to meet the required premium payments on the life insurance policy. The investor and the nonprofit entity may form a partnership, which both owns the annuity and the beneficial interest in the life insurance policy. The partnership makes annual contributions to the nonprofit which has a partnership interest. Any residual cashflows from the partnership may be elected to be received by the investor as an economic return for committing his capital to the partnership.

By separating the role of policy finding from the role of the insured in a planned giving context, the nonprofit entity is able to generate a substantial and reliable annual income stream stemming from the combined participation of its benefactors—both financial and insured—without bearing the risk of financing the insurance policies on its own or hoping that the donor of life insurance will in fact continue to make premium payments on the policy to maintain it in force. The above described method of planned giving may be called the Charitable Annuity Program (“CAP”), which integrates and extends the best features of planned giving of life insurance and charitable gift annuities in a manner which generates substantial cashflows to nonprofit entities, but without the uncertainty and risk associated with placing entire reliance upon the insureds to make the necessary premium payments. A defining characteristic of a CAP program is that without the support of the investors in the nonprofit's financial benefactor, the donation of the life insurance policy by the insured benefactor would have an uncertain value. By contrast, due to the support of the investors in the nonprofit entity's financial benefactor in the present invention, a life insurance policy donated by an insured benefactor to the nonprofit has substantial and tangible economic value to nonprofit that is realized in the form of recurring annual payments received by the nonprofit.² ² Though the value of an insurance policy donated by a benefactor to the nonprofit entity may not be known a priori, it is evident from the significant funding generated for the nonprofit, as a result of the donation, that a donated life insurance policy—even in the absence of a commitment to fund the policy by the donor—has a material economic value.

This happy intersection of the financial contributions provided by the investors in the nonprofit's financial benefactor and the willingness of the nonprofit's insured benefactors to become insureds will produce substantial and recurring economic support for the nonprofit entity according a method and system of the present invention. Furthermore, this support is guaranteed to recur for time horizons from ten to twenty years or longer, freeing the nonprofit to focus itself on grant-making rather than on fundraising. The existence and magnitude of this support would not exist without the critical contributions of both the nonprofit's financial and insured benefactors.

According to another embodiment, as described herein, a method, system and plan for using life insurance products to achieve a simultaneous increase in donor life insurance and annuity related gifts to universities and colleges and other nonprofit entities and optimized excess returns on university and college endowment investment funds and other investment funds, comprises the steps of:

1) determining the required return on investment funds;

2) selecting from among a database of prospective donors or insured benefactors who desire to support a given nonprofit entity such as the alumni of universities and colleges a defined pool of insured donors or insured benefactors based upon their age, health status, net worth, donative desire and intent, and other characteristics;

3) obtaining the consent for the nonprofit entity to purchase, own, or become beneficiary of a life insurance policy on the life of each insured benefactor;

4) creating a partnership, limited liability corporation, or similar entity for the purposes of funding the life insurance policies and annuity contracts to be purchased;

5) having the nonprofit entity (e.g., university or college) assign its beneficial interest in the life insurance policy purchased on the insured benefactor in exchange for an equity interest in the partnership, limited liability corporation or similar entity;

6) obtaining an equity or debt investment from an investor in the partnership or limited liability corporation;

7) having the partnership or limited liability corporation procure the consent of the insured benefactor to purchase an annuity on the life of the insured benefactor;

8) purchasing a single premium immediate annuity (“SPIA”) with a life only payment option or other payment options on the life of the insured benefactor using all or part of the investment;

9) optionally having another equity investor in the partnership to provide additional equity or debt financing whereby such financing may be used to efficiently finance the death benefit on the purchased life insurance policy;

10) distributing either a portion of the annuity cashflows received by the partnership, limited liability corporation or similar entity to the nonprofit entity on a periodic basis or allowing a distribution from the cash value of the life insurance policy to the nonprofit entity on a periodic basis;

11) distributing some or all of a portion of the annuity cashflows received by the partnership, limited liability corporation or similar entity to the first investor on a periodic basis as required by the financial benefactor (the partnership or the limited liability corporation) or allowing a distribution from the cash value of the life insurance policy to the first investor on a periodic basis; and

12) distributing some or all of a portion of either the annuity cashflows received by the partnership, limited liability corporation or similar entity to any additional investors or financial partners in the partnership or limited liability corporation on a periodic basis or allowing a distribution from the cash value of the life insurance policy to the additional investors or financial partners on a periodic basis.

In another additional embodiment, a method for enabling donations to a nonprofit entity, includes the step of donating an insurance policy to the nonprofit entity, or providing consent for the nonprofit entity to own or purchase the insurance policy. The nonprofit entity assigns a beneficial interest to a financial benefactor in exchange for a consideration from the financial benefactor, and the nonprofit entity provides the financial benefactor with an opportunity to finance the insurance policy.

In another additional embodiment, a method for a nonprofit entity to process donations includes the steps of: receiving a donor's consent to hold an insurance policy insuring the donor; assigning the insurance policy's beneficial interest to a financial benefactor; providing the financial benefactor with the opportunity to finance the insurance policy; and receiving an ownership interest in the financial benefactor.

In another additional embodiment, a method for enabling donations to a nonprofit entity, includes the steps of: assigning to another entity a payout of an insurance policy held by the nonprofit entity insuring a donor; assigning an opportunity to finance the insurance policy to the other entity; and receiving consideration from the other entity.

In another additional embodiment, a method for facilitating donations to a nonprofit entity, includes the steps of: receiving a beneficial interest to an insurance policy held by the nonprofit entity; receiving an opportunity to maintain the insurance policy in force; using at least some financing to maintain the insurance policy in force; and providing the nonprofit entity with a right to a distribution from assets including the insurance policy and the financing. The insurance policy insures a donor to the nonprofit entity, even though the insurance policy is owned, purchased or otherwise held by the nonprofit entity.

In another additional embodiment, a method for a financial benefactor to enable donations to a nonprofit entity, includes the steps of: financing an insurance policy held by the nonprofit entity; providing consideration to the nonprofit entity; and receiving a right to a payout of the insurance policy from the nonprofit entity. The consideration can include an ownership interest provided to the nonprofit entity through a class of shares issued to the nonprofit entity, or through other means. The insurance policy insures a donor to the nonprofit entity, even though the insurance policy is owned, purchased or otherwise held by the nonprofit entity.

In another additional embodiment, a method for facilitating donations to a nonprofit entity, includes the steps of: providing financing to a financial benefactor of the nonprofit entity, and receiving a respective right to the distribution from assets of the financial benefactor. The provided financing is contributed into the financial benefactor's total financing. The financial benefactor applies at least some of its total financing towards maintaining an insurance policy in force for the nonprofit entity. The insurance policy insures a donor to the nonprofit entity, even though the insurance policy is owned, purchased or otherwise held by the nonprofit entity. The nonprofit entity assigns a beneficial interest under the insurance policy to the financial benefactor in exchange for a respective right to a distribution from assets of the financial benefactor. The assets of the financial benefactor include a value of the insurance policy to the financial benefactor, and may include the value of an annuity purchased for the life of the donor, as well as values of other insurance policies and annuities on other donors.

In another additional embodiment, a method for enabling donations to a nonprofit entity, includes the steps of: receiving an assignment from the nonprofit entity of a death benefit of a life insurance policy held by the nonprofit entity; receiving an opportunity to maintain the life insurance policy; receiving or accepting financing, for example, from outside sources; and providing the nonprofit entity with a right to a first portion of a distribution from assets, including a value of the death benefit of the life insurance policy. The received or accepted financing is contributed into a pool of total financing, at least some of which is allocated towards maintenance of the life insurance policy for the nonprofit entity. The insurance policy insures a donor to the nonprofit entity, even though the insurance policy is owned, purchased or otherwise held by the nonprofit entity.

In another additional embodiment, a method for a nonprofit entity to facilitate donations, includes the steps of: owning or purchasing a life insurance policy insuring a life of a donor; assigning a death benefit of a life insurance policy to a financial benefactor; providing an opportunity to maintain the life insurance policy to the financial benefactor; and receiving a right to a first portion of the distribution by the financial benefactor from assets of the financial benefactor including a value of the death benefit of the life insurance policy. The financial benefactor receives financing which is contributed into a total financing of the financial benefactor, at least some of which is allocated towards the maintenance of the life insurance policy.

In another additional embodiment, a method for a party with an insurable interest in a life insurance policy to enable donations to a nonprofit entity, includes the step of: donating the life insurance policy to the nonprofit entity. The nonprofit entity assigns a death benefit of the life insurance policy to a financial benefactor in exchange for a right to a first portion of a distribution from assets of the financial benefactor. The assets of the financial benefactor include a cash value of the life insurance policy. The financial benefactor receives or accepts an opportunity to maintain the life insurance policy for the nonprofit entity, and receives or accepts financing, as part of the financial benefactor's total financing. At least some of the financial benefactor's total financing is allocated to maintain the life insurance policy for the nonprofit entity.

In another additional embodiment, a method for a party with an insurable interest in a life insurance policy to enable donations to a nonprofit entity, includes the step of: providing consent to a nonprofit entity to obtain the life insurance policy. The nonprofit entity assigns a death benefit of the life insurance policy to a financial benefactor in exchange for a right to a first portion of a distribution from assets of the financial benefactor. The assets of the financial benefactor include a cash value of the life insurance policy. The financial benefactor receives or accepts an opportunity to maintain the life insurance policy for the nonprofit entity, and receives or accepts financing, as part of the financial benefactor's total financing. At least some of the financial benefactor's total financing is allocated to maintain the life insurance policy for the nonprofit entity.

In another additional embodiment, a method for facilitating donations to a nonprofit entity, includes the steps of: providing financing to a financial benefactor of the nonprofit entity; and receiving a right to a respective portion of a distribution from assets of the financial benefactor including a cash value of the life insurance policy and the annuity, through a class of shares issued by the financial benefactor or through other means. At least part of the provided financing is applied to maintaining an insurance policy in force for the nonprofit entity, and/or purchasing an annuity. The life insurance policy, insuring a life of a donor, is held by the nonprofit entity. The nonprofit entity assigns a death benefit on the life insurance policy to the financial benefactor in exchange for a right to a respective portion of the distribution. The financial benefactor purchases the annuity on the life of the donor to provide annuity payments to the financial benefactor for the life of the donor. The financial benefactor has an opportunity to maintain the life insurance policy.

In another additional embodiment, a method of facilitating donations to a nonprofit entity includes the steps of: issuing a life insurance policy on a life of a consenting donor to a nonprofit entity; and accepting or receiving premium payments on the life insurance policy from a financial benefactor of the nonprofit entity. The nonprofit entity assigns a death benefit of the life insurance policy to a financial benefactor in exchange for an interest in a portion of a distribution from assets of the financial benefactor. The assets of the financial benefactor include a cash value of a life insurance policy and an annuity purchased by the financial benefactor to provide annuity payments to the financial benefactor for the life of the donor.

In another additional embodiment, a method of facilitating donations to a nonprofit entity includes the steps of: issuing a life insurance policy to a donor on a life of the donor, the donor providing consent to the nonprofit entity to own or purchase a life insurance policy on the life of the donor; and receiving premium payments on the life insurance policy from the financial benefactor. The nonprofit entity assigns a death benefit of the life insurance policy to a financial benefactor in exchange for an interest in a portion of a distribution from assets of the financial benefactor. The assets of the financial benefactor include a cash value of a life insurance policy and an annuity purchased by the financial benefactor to provide annuity payments to the financial benefactor for the life of the donor.

In another additional embodiment, a method of facilitating donations to a nonprofit entity includes the step of: selling an annuity to a financial benefactor of a nonprofit entity. The nonprofit entity owns, purchases or otherwise holds a life insurance policy on a life of a donor, and assigns a death benefit under the policy to the financial benefactor. The financial benefactor maintains the life insurance policy for the nonprofit entity and purchases the annuity to provide the financial benefactor with annuity payments for the life of the donor. The financial benefactor distributes a first portion of the annuity payments to the nonprofit entity and other portions of the annuity payments as payments on financing provided to the nonprofit entity for the maintenance of the life insurance policy and the purchase of the annuity.

In another additional embodiment, a method of facilitating donations to a nonprofit entity includes the steps of: lending an amount to another entity, the lent amount being invested by the other entity in a financial benefactor of a nonprofit entity; and receiving payments from the other entity. The financial benefactor uses the invested lent amount to maintain a life insurance policy held by the nonprofit entity on a life of a donor. The financial benefactor also purchases an annuity to provide the annuity payments for the life of the donor with other invested funds. The nonprofit entity assigns a death benefit of the life insurance policy to the financial benefactor in exchange for a right to a first portion of annuity payments from the financial benefactor. The financial benefactor provides a second portion of the annuity payments as payments on the other invested finds, and a third portion of the annuity payments to the other entity.

In another additional embodiment, a vehicle for facilitating donations to a nonprofit entity includes: an instrument for providing consent of a donor to a life insurance carrier to issue a life insurance policy on a life of the donor to a nonprofit entity. The nonprofit entity assigns a death benefit on the life insurance policy to a financial benefactor in exchange for a portion of a distribution from assets of the financial benefactor. The assets of the financial benefactor include a cash value of the life insurance policy and an annuity purchased by the financial benefactor providing annuity payments to the financial benefactor for the life of the donor.

In another additional embodiment, an instrument for facilitating donations to a nonprofit entity includes a life insurance policy on a life of a donor to the nonprofit entity. The nonprofit entity is the owner of the life insurance policy, and assigns a death benefit of the life insurance policy to a financial benefactor of the nonprofit entity. The financial benefactor maintains the life insurance policy and purchases an annuity on the life of the donor to provide the financial benefactor with annuity payments for the life of the donor. The financial benefactor provides a first portion of the annuity payments to the nonprofit entity.

In another additional embodiment, an investment vehicle in a financial benefactor of a nonprofit entity includes a tradable instrument providing investment capital to the financial benefactor. The investment capital is contributed and part of the financial benefactor's total financing. The financial benefactor maintains a life insurance policy held by the nonprofit entity on a life of a donor with a portion of its total financing. The financial benefactor purchases an annuity with another portion of the total financing to provide the annuity payments to the financial benefactor for the life of the donor. The nonprofit entity assigns a death benefit of the life insurance policy to the financial benefactor in exchange for a right to a first portion of annuity payments from the financial benefactor.

In another additional embodiment, an instrument for facilitating donations to a nonprofit entity includes an annuity providing annuity payments to a financial benefactor of the nonprofit entity for a life of a donor. The financial benefactor allocates a portion of the annuity payments to the nonprofit entity in exchange for a death benefit of the life insurance policy, and maintains the life insurance policy for the nonprofit entity.

In another additional embodiment, a debt investment vehicle to facilitate donations to a nonprofit entity includes: a loan to an investor, the investor investing a principle of the loan in a financial benefactor of the nonprofit entity. The financial benefactor uses the loan to maintain a life insurance policy held by the nonprofit entity on a life of a donor. The financial benefactor purchases an annuity to provide annuity payments for the life of the donor with other invested funds. The nonprofit entity assigns a death benefit of the life insurance policy to the financial benefactor in exchange for a first portion of annuity payments from the financial benefactor. The financial benefactor allocates a second portion of the annuity payments for payments on the loan, and a third portion of the annuity payments as payments on the other invested funds used to purchase the annuity.

In another additional embodiment, a method of facilitating donations to a nonprofit entity includes the step of forming an entity to be the financial benefactor of the nonprofit entity. The formed entity accepts an assignment of a death benefit of the life insurance policy from the nonprofit entity. The formed entity accepts invested capital from at least one primary investor for maintaining the life insurance policy, and accepts invested capital from at least one secondary investor for purchasing an annuity to provide the entity with annuity payments for the life of the donor. The formed entity grants an ownership interest to each of the nonprofit entity, the at least one primary investor and the at least one secondary investor. Each ownership interest in the formed entity entitles its respective holder to a portion of a distribution from assets of the entity. The assets of the entity include a cash value of the life insurance policy and the annuity payments.

In another additional embodiment, a system enabling donations to a nonprofit entity, includes: a donor; a nonprofit entity holding a life insurance policy on a life of a donor; and a financial benefactor to the nonprofit entity. The financial benefactor has an annuity providing annuity payments on the life of the donor, and maintains the life insurance policy for the nonprofit entity. The financial benefactor has a right to a death benefit of the life insurance policy, and provides the nonprofit entity with a portion of the annuity payments. The financial benefactor may provide additional portions of the annuity payments to its investors.

In another additional embodiment, an investment vehicle for facilitating donations to a nonprofit entity, includes a bond entitling a bearer of the bond with a right to a coupon payment and a repayment of a principal amount of the bond from a financial benefactor of the nonprofit entity. The nonprofit entity holds a life insurance policy on a life of a donor. The nonprofit entity assigns a death benefit of the life insurance policy to the financial benefactor. The financial benefactor maintains the life insurance policy and purchases an annuity providing the financial benefactor with annuity payments for the life of the donor. The financial benefactor provides periodic payments to the nonprofit entity backed by a first portion of distributions from assets including a cash value of the life insurance policy and the annuity. The coupon payments are backed by a second portion of the distributions by the financial benefactor. The repayment of the principal amount of the bond is backed by a portion of the death benefit provided to the financial benefactor.

In another additional embodiment, an instrument for facilitating donations to a nonprofit entity includes an insured annuity. The insured annuity includes a life insurance policy and an annuity. The life insurance policy insures a life of an insured benefactor to the nonprofit entity. The annuity provides annuity payments for a period of time, including, for example, a measured life of the same insured benefactor. However, the life insurance policy may insure the lives of more than one insured benefactor to the nonprofit entity. Similarly, the annuity may provide annuity payments for a measured life of another insured benefactor, or for the measured lives of more than one insured benefactor. The life insurance policy is owned by the nonprofit entity. The nonprofit entity assigns at least a portion of the death benefit under the policy to a nonprofit development partner to the nonprofit entity, in exchange for consideration provided to the nonprofit entity from the nonprofit development partner, which may include a first portion of distribution from assets of the nonprofit development partner, including a cash value of the life insurance policy and the annuity payments. The nonprofit development partner maintains the life insurance policy with financing arising from debt financing provided by a bank to one of a preferred investor in the nonprofit development partner, or provided by the bank to the nonprofit development partner directly. The life insurance policy can also be maintained by the nonprofit entity with debt financing provided by the bank to the nonprofit entity. The annuity can be purchased by the nonprofit development partner with financing arising from equity financing provided by the equity investor, or may be purchased by the equity investor directly. The insured annuity provides the nonprofit entity with consideration in exchange for the assignment of the portion of the death benefit to the nonprofit development partner.

In another additional embodiment, a method for enabling donations to a nonprofit entity includes the steps of: receiving an assignment from the nonprofit entity of a death benefit of a life insurance policy held by the nonprofit entity, the life insurance policy insuring a life of a donor; receiving an opportunity to maintain the life insurance policy; receiving financing arising from debt financing, which is allocated for maintaining the life insurance policy; receiving a loan guaranty from an equity investor for the debt financing, providing consideration to the equity investor for the loan guaranty; and providing the nonprofit entity with a right to a first portion of a distribution from assets, the assets including a value of the death benefit of the life insurance policy. The loan guaranty may be in the form of a collateral assignment in an asset of the equity investor. The asset may be a charitable gift annuity purchased by the equity investor from the nonprofit entity. The charitable gift annuity may provide the equity investor with charitable gift annuity payments during a measured life of at least one insured benefactor to the nonprofit entity. The nonprofit entity may finance the charitable gift annuity payments by purchasing a commercial annuity from an annuity carrier, and allocating a portion of the commercial annuity payments to cover the charitable gift annuity payments. The nonprofit entity thus retains a portion of the commercial annuity payments, in addition to receiving consideration from the nonprofit development partner for assigning a portion of the death benefit to the nonprofit development partner.

In another additional embodiment, a method for facilitating donations to a nonprofit entity includes the steps of: purchasing a charitable gift annuity from the nonprofit entity to receive charitable gift annuity payments from the nonprofit entity on a measured life of at least one insured benefactor to the nonprofit entity; offering a loan guaranty to the nonprofit entity, the nonprofit development partner, the preferred equity investor in the nonprofit development partner, and/or the bank on debt financing provided by the bank to the nonprofit entity, the nonprofit development partner and/or the preferred equity investor; and receiving consideration for the loan guaranty from the nonprofit entity, the nonprofit development partner, the preferred equity investor and/or the bank. The nonprofit entity may fund the charitable gift annuity payments with a portion of commercial annuity payments from a commercial annuity purchased by the nonprofit entity from an annuity carrier. Alternatively, the nonprofit entity may fund the charitable gift annuity payments with returns on other assets of the nonprofit entity. The nonprofit entity owns at least one life insurance policy insuring the lives of one or more insured benefactors to the nonprofit entity. The nonprofit entity assigns at least a portion of a death benefit under the life insurance policy to the nonprofit development partner. The debt financing from the bank is used to generate funds (or used directly) towards covering the premiums or otherwise maintaining the life insurance policy, whether the policy is maintained by the nonprofit entity, the non-profit development partner, the preferred equity investor and/or directly by the bank. The loan guaranty provided by the equity investor may include a collateral assignment in the charitable gift annuity payments or other assets of the equity investor.

### BRIEF DESCRIPTION OF THE DRAWINGS

FIG. 1 is a schematic representation of a system and method for enabling donations of life insurance proceeds to nonprofit entities, such as university/college gift programs according to a first embodiment of the present invention.

FIG. 2 is a chart illustrating the analysis of a portfolio of life insurance policies for the system presented in FIG. 1.

FIG. 3 is a schematic representation of a system and method for enabling donations of life insurance proceeds to nonprofit entities, such as university/college gift programs according to another embodiment of the present invention.

FIG. 4 is a schematic representation of a system and method for enabling donations of life insurance and annuity proceeds to nonprofit entities such as university/college gift programs, according to another embodiment of the present invention.

FIG. 5 is a schematic representation of a system and method for enabling donations of life insurance and annuity proceeds to nonprofit entities such as university/college gift programs, according to another embodiment of the present invention.

### DETAILED DESCRIPTION

The present invention is described in relation to systems, methods, products and plans for the simultaneous enablement or facilitation of donations of life insurance proceeds to beneficiaries such as individuals, for-profit entities or nonprofit entities at no cost to the benefactors or donors, while enhancing the returns of the investment finds supporting such donations.

In a first embodiment of the present invention, systems, methods, products and plans for the simultaneous enablement or facilitation of donations of life insurance proceeds to donations to nonprofit entities, such as colleges and universities, are described, although the description is applicable to other types of nonprofit entities or institutions, as well.

Colleges and universities are good candidates as nonprofit entities that can benefit from the donation of life insurance proceeds according to the present invention for reasons not limited to the following:

1) Potential donor databases are naturally selected by age or mortality risk, e.g., most alumni fund raising is organized and targeted based upon year of graduation, thus providing a readily available cohort of donors that potentially would possess desirable life insurance underwriting criteria;

2) Potential donors are also naturally selected in terms of household income and net worth. For example, many graduates of the professional schools of ivy league universities have a high household net worth that would qualify for underwriting substantial amounts of life insurance on the donor graduate; and

3) Universities and colleges have long duration investment horizons. These long duration horizons are ideally suited to the duration profile of life insurance contracts; and

4) For the first embodiment of the present invention, universities and colleges have endowment investment funds that are separate nonprofit funds (or nonprofit entities) from universities and colleges but related to the universities and colleges, providing funds to the universities and colleges. For example, a university fund management company is a distinct nonprofit entity from the university. Donors desire to make charitable gifts and donations to the universities and colleges, in many cases designating specific uses for the gifts, e.g., endowing a professorship in a certain academic department. Endowment investment funds, on the other hand, are often run by professional investment managers who use the same investment criteria and sophisticated risk management techniques as do other for-profit investment managers. The separation of governance and control of the two entities allows for the methods of the present invention to operate more efficiently. In particular, the methods and systems of the present invention optimally serve both distinct entities, in terms of providing superior investment performance to the endowment investment funds while also generating large donations to the colleges and universities themselves, at no cost to the donors;

5) Both the endowment investment funds and the universities and colleges have an insurable interest in their donor alumni and other benefactors. The insurable interest in one based upon the continued receipt and expectation of future donations and other types of institutional support (e.g., organizing other alumni charitable activities). This insurable interest is demonstrably stronger than that of most charitable institutions; and

6) Additionally, unlike other charitable institutions, the endowment investment funds can provide an accessible source of capital to purchase life insurance policies as set forth in more detail below.

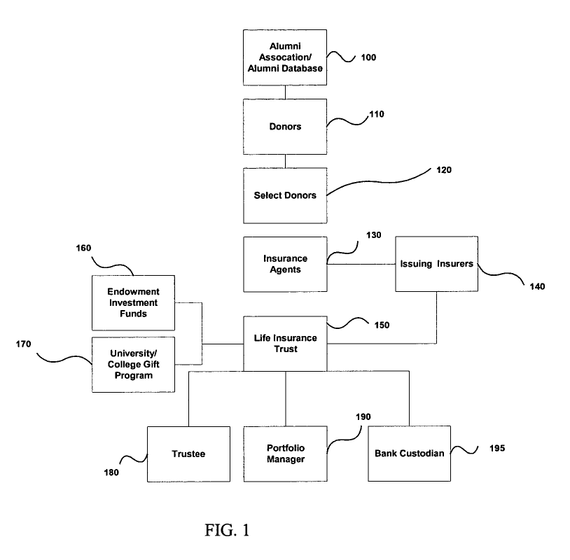

FIG. 1 is a schematic representation of a system for creating simultaneous excess risk adjusted returns for university and college endowment investments funds and substantial donations to the gift programs of such colleges and universities without cost to the donors according to a first embodiment of the present invention. The system may comprise an university or college alumni database, 100, a cohort of potential donors 110, a cohort of select donors 120, participating insurance agents 130, issuing life insurers 140, life insurance trust 150, endowment investment funds 160, gift programs 170, life insurance trust trustee 180, portfolio manager 190, and bank custodian 195. As illustrated in FIG. 1, various parts of the system may interact with other parts of the system via exchange of information and cashflows pursuant to financial transactions.

In this embodiment, alumni database component 100 is obtained from university and college alumni associations. The database is searched initially for a cohort of potential donors 110. For example, all donor alumni graduating in the year 1955 and earlier might be searched and compiled into a list of potential donors 110.

The universe of potential donors 110 is then filtered by select underwriting criteria to form a list of select donors 120. Such criteria, can include age, health status, sex, occupation, employment status, household income and net worth, country of origin, current location of residence, and other criteria. For example, as described more fully below, select donors 120 can comprise alumni males age 75 and older (80 and older for females) who each have a net worth of at least 1 million dollars. Additionally, the amount of insurance currently held by the select donors 120 could be required, such that an additional amount of permanent or term life insurance in amounts exceeding, for example, US$500,000 would be available for underwriting, given the donor's age, health status, and net worth.

A list of select donors 120, is then made available to insurance agents 130. The insurance agents: (1) contact the select donors; (2) obtain necessary medical information regarding the select donors; and (3) process life insurance applications on the select donors for universal, whole, variable universal, or term life insurance. The insurance agents 130 seek to find the most attractive, e.g., the lowest premium rates, for a given death benefit for a select donor 120. Finding the lowest premium rates for a given death benefit may require the insurance agent to make inquiries to multiple life insurance companies to determine which companies will be the issuing insurers 140.

In one embodiment, the majority of policies to be underwritten on the select donors 120 are universal life (UL) policies. Such UL policies allow for flexible premium payment schedules and the ability to also flexibly alter the amount of coverage. In addition, UL policies can have generous interest rates which apply to premium balances in excess of those minimally required to prevent the policy from lapsing. UL policies also provide the ability to pay a target to planned premium or a guaranteed premium. The planned premium is the premium paid periodically, which given current forecasts of mortality charges, will keep the policy in force until the policy maturity date—which may be either the date of death or age 100 or 120. The guaranteed premium is the premium which can be paid that will guarantee that the policy will not lapse even if higher than expected mortality charges occur. Finally and as described in more detail below, competitive underwriting pressures for UL policies across different issuing insurers may allow select donors 120 to obtain favorable expected costs of insurance.

Life insurers 140 comprise the insurance companies which underwrite or issue universal, whole, variable, universal, or term life insurance on the lives of the select donors 120. Insurance agents 130 will have established relationships with the life insurers 140 that possess adequate credit ratings, such as a rating of A or better by A.M. Best, Standard and Poor's, Moodys, Fitch or other similar rating agencies.

Life insurance trust 150 can be an Irrevocable Life Insurance Trust or ILIT, to be settled by each respective grantor (or settlor) of select donor 120. The select donor 120 is the grantor of the trust and irrevocably gives up all rights to the trust assets. One consequence of life insurance trust 150's construction as an ILIT is the ability to minimize or eliminate any estate tax consequences of the assets held in trust. Each select donor 120 is the insured of his respective ILIT 155. Each ILIT 155 has a trust indenture or trust agreement, which enumerates the purposes of the trust, the property held by the trust, the trust beneficiaries, and how the trust property is to be distributed.

Each ILIT 155, will contain one or more insurance policies contracted by insurance agents 130, on the life of the select donor 120. As indicated previously and as described in more detail below, the majority of life insurance policies on the life of each respective select donor 120 in the ILIT 155 may be universal life policies. Other policy types, however, such as second-to-die, may be included.

The trust agreement for the ILIT 155, will name at least two or three irrevocable beneficiaries. In other embodiments, different numbers of beneficiaries may be named. In this embodiment both the endowment investment fund 160, and the gift program of the respective university or college 170 are named as irrevocable beneficiaries of the ILIT 155. For example, University X Management Company, the endowment investment fund which manages the investments of University X, would be named as a irrevocable beneficiary of ILIT 155, as well as the gift program of University X. Since both are nonprofit institutions, they will either be exempted from the insurable interest requirements of many states (e.g., New York Insurance Laws Section 3205(a)(3)) or will naturally be deemed to have an insurable interest in the select donor alumnus whose life is being insured.

Alternatively in other embodiments, the beneficiaries may be revocable as well as irrevocable. A beneficiary which is irrevocable has a stronger property right in the trust assets and, for example, must provide consent to such matters as changing the trust agreement, changing the beneficiary, distribution of trust assets not in accordance with the trust document, and other such matters.

The endowment investment finds 160 finance the purchase of the life insurance policies through insurance agents 130 from issuing insurers 140 by paying the periodic premiums required to maintain the policy in force. Such premiums are referred to as “no lapse” premiums or target premiums. As indicated above, universal life insurance policies allow great flexibility as to the size and timing of the minimum premiums required to keep the policy from lapsing. The trustee 180 of ILIT 155 is appointed to enforce the trust document and represent the interests of the beneficiaries. Some of the duties of the trustee include, but are not limited to: (1) opening a bank account with bank custodian 195 for the purpose of depositing cash received from endowment investment funds 160, and paying premiums to the issuing insurers 140; (2) collecting death benefits upon the death of the insured from the issuing insurers 140; and (3) disbursing the death benefits to the respective beneficiaries.

In consultation with the endowment investment fund 160, the university or college gift program 170 and the select donor 120, the portfolio manager 190 will advise on the type of life insurance policy to be purchased and the method of splitting the death benefit among the endowment investment fund 160, and the university or college gift program 170. In this embodiment, the goal is to split the death benefits between the endowment investment fund 160 and the university or college gift program 170 in such manner so as to provide: (1) significant incentives for the select donors 120 to participate in the plan by making available large life insurance gifts in their name; and (2) providing excess risk adjusted returns to the endowment investment funds 160 on a portfolio of life insurance policies on select donors 120 in which they have invested the premiums. For example, the portfolio manager 190 might determine, using methods described in detail below, that for an insurance policy with a $10 million death benefit, $2 million should go to the university or college gift program 170 for the first 5 years, $1 million for the next five years, and $500,000 thereafter. The remainder of the death benefit reverts to the endowment investment fund 160 to provide, on a portfolio of such policies, a risk adjusted excess return on its investment capital. Once the portfolio manager 190 and the beneficiaries have decided the optimal combination of donations and returns, the split of the death benefit of the policy between the beneficiaries is incorporated into the trust document of the ILIT 155.

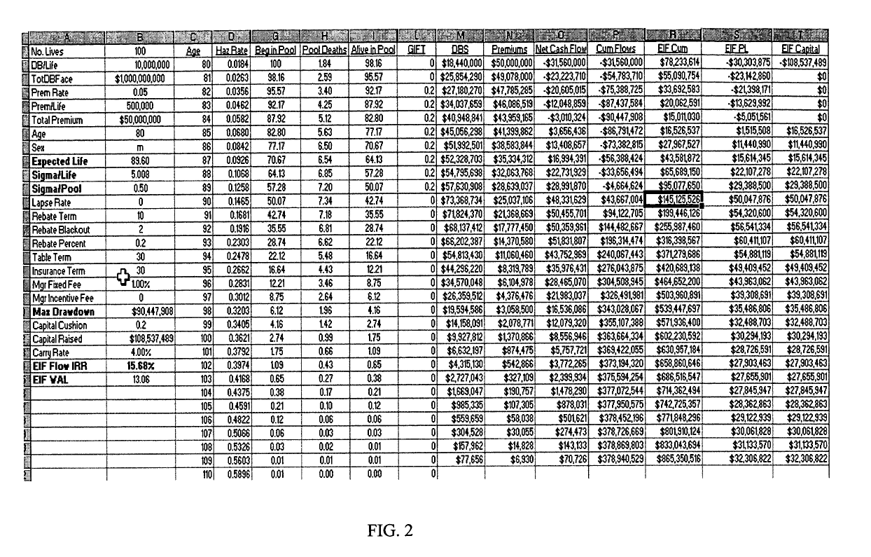

FIG. 2 is a spreadsheet chart illustrating the investment analysis of the portfolio manager 190. The chart illustrates both the parameter inputs and parameter outputs, which are relevant to the portfolio manager 190 in determining the required rate of return to the endowment investment fund 160 (EIF) and the donee university or college gift program 170 (GIFT). Column A of FIG. 2 illustrates these parameters which include, but are not limited to: (1) the number of lives to be insured (B1); (2) the average death benefit per life (B2); (3) the total death benefit for all of the insured lives (B3); (4) the target premium rate (B4) expressed as a percentage of the death benefit per life (B2); (5) the annual target premium per select donor life (B5) which is equal to the product of the target premium rate (B4) multiplied by the death benefit per life (B2); (6) the total initial target premium (B6) which is equal to the product of the annual target premium per select donor life (B5) and the number of select donor lives insured (B1); (7) the average age of the select donor 120 (B7); (8) the sex of the select donor lives under analysis (B8); (9) the calculated expected life span of the select donor life (B9) using mortality data such as the recently approved 2001 Commissioners Standard Ordinary (CSO) Male NonSmoker Select Tables; (10) the calculated standard deviation for each representative donor life (B10); (11) the standard error around the mean donor life expectancy for the entire pool (B1) which is equal to the standard deviation per select donor life (B10) divided by the number of select donors to be insured (B1); (12) the number of policies which will be allowed to lapse per year and will not be kept in force (B12) (in one embodiment, the lower the lapse rate, the higher the expected rate of return to the EIF); (13) the number of years during which the select donor's portion of the death benefit will be paid to the university or college of the select donor's choice (B13); (14) the number of initial years during which no benefit will be paid to the university or college, which in one embodiment, will be set at two years so as to correspond to standard no contestability clauses found in life insurance contracts; (15) the percentage of the total death benefit per select donor 120 (B2) which is to be donated to the university or college beneficiary selected by the donor 120 (B15); (16) the maximum age to which the mortality table being extends, in years, from the average age of the insured select donor (B 16); (17) the average term of the insurance policy purchased during which a death benefit will be paid (B17); (18) the fee paid to the portfolio manager 190 as a fixed percentage of assets invested by the EIF; (19) the fee paid to the portfolio manager as a fixed percentage of profits, which can be set at zero (B19); (20) the expected net funding requirement needed in the first several years of the plan of the present invention for premium payment to maintain the life insurance policies on the select donors in force (B20); (21) the amount of capital to be raised in excess of the expected net 120 funding requirement as a percentage increase of the net funding requirement (B21); (22) the capital requirement to be invested by the EIF 160 (B22) which is one plus the “capital cushion” of (B21) multiplied by the net expected funding requirement of (B20); (23) the minimum rate of interest to be applied to excess capital not invested in the life insurance policies (B23); (24) the calculated internal rate of return on invested capital to the EIF 160 net of fees for the portfolio manager 190 (B24) and; (25) the calculated weighted average life of the investment to the EIF 160 in years (B25).

The analysis of the portfolio manager 190 will also include relevant mortality data. For example, column D of FIG. 2 contains actuarial hazard rates for an 80 year old male nonsmoker from the 2001 CSO Select table. An actuarial hazard rate measures the rate at which remaining lives of a cohort die in a given year. Columns G, H, and I of FIG. 2 apply these hazard rates to the select donor pool of 100 lives (B1 ). For example, after 2 years, when the males originally age 80 are now aged 82, on average 4.43 deaths would have occurred leaving only 95.57 select donors on average alive out per 100 select donors originally in the plan. Other mortality data may be used as is relevant. Such data may be obtained from websites or a variety of other sources.

Referring again to FIG. 2, column M computes the death benefits (assumed payable at the end of the year) given the number of statistical deaths contained in column H. Each row of column M is therefore equal to the product of the respective row in column H multiplied by the death benefit per life contained in (B2). Column N contains the premium payments required to be made to keep the life insurance policies in force for those select donors 120 still alive at the beginning of the year indicated in Column C. For example, cell (N3) indicates a required premium of $49,078,000 which is the product of the number of select donors 120 alive at the beginning of the year on average (equal to 98.16 in cell (G3)) multiplied by the annual premium per select donor 120 (B5). Column O contains the Net Cash Flows for each year which are equal to the respective death benefits of Column M less the premium outlays of Column N. As can be seen from FIG. 2, in the early years of the plan of the present invention, the net cash flows are negative meaning that more premiums must be paid than death benefits are received.

Column P of FIG. 2, contains the cumulative net cash flows, which is a running sum of Column O. As can be seen, the minimum of Column P is equal to −$90,447,908 which is equal to the maximum drawdown or expected net funding requirement of cell (B20) from which the required investment capital of the EIF 160 is computed. Column R contains a cumulative total of the investment account of the EIF 160 assuming the capital investment of cell (B22) is used and the net cash flows of Column O. Column S shows the profit and loss for each year to the EIF 160 assuming the interest rate of (B23) on uninvested balances and net of the management fees of (B18) and (B19). Finally, Column T shows the capital account of the EIF 160 from which investment returns are computed. As can be seen from (T2), the EIF 160 first makes an upfront investment of $108,537,489 as is shown in (B22). While the net cash flows in column O are negative, the EIF 160 receives no return on capital. As soon as the net cash flows in column O are positive, the EIF 160 receives its portion of such cash flows net of any portfolio manager fees plus an uninvested balances which have been invested at the interest rate of (B23). Other embodiments for computing the returns on EIF capital are possible.

The internal rate of return on the cash flows contains in column T are then computed by the portfolio manger using standard techniques. The internal rate of return is reported in (B24). Additionally, the portfolio manager 160 may compute, a measure of the duration of the returns to be obtained from the life insurance investments.

One such measure is known as the Weighted Average Life, or WAL, as is reported in (B25). The units of WAL are in years which give a relative indication of the investment horizon of a given investment. Investments in life insurance policies on select donors 120 may have WAL's which range from 5-20 years, though shorter or longer WAL's are possible.

After the portfolio manager 190 has performed the calculations as illustrated in FIG. 2, (s)he may then vary certain parameters to determine their influence on: (1) the amount of life insurance that can be donated to the college or university gift program 170; (2) the returns on capital invested by the endowment investment funds 160; (3) the weighted average life of the investment. For example, increasing the term or the size of the life insurance donation of which the university or college is a beneficiary will both reduce the rate of return on capital to the EIF 160 and extend the WAL of the investment. The portfolio manager 190 may also investigate the effect of lower premium rates on EIF 160 returns on investment, for example, and may decide to make inquiries of additional insurance companies for the purpose of receiving a more favorable premium for the same death benefit. Other variations of the parameters are possible in order to obtain a simultaneous amount of life insurance to be donated by the select donor 120 and the required return on investment capital for the EIF 160 which make both beneficiaries eager participants of the plan of the present invention.

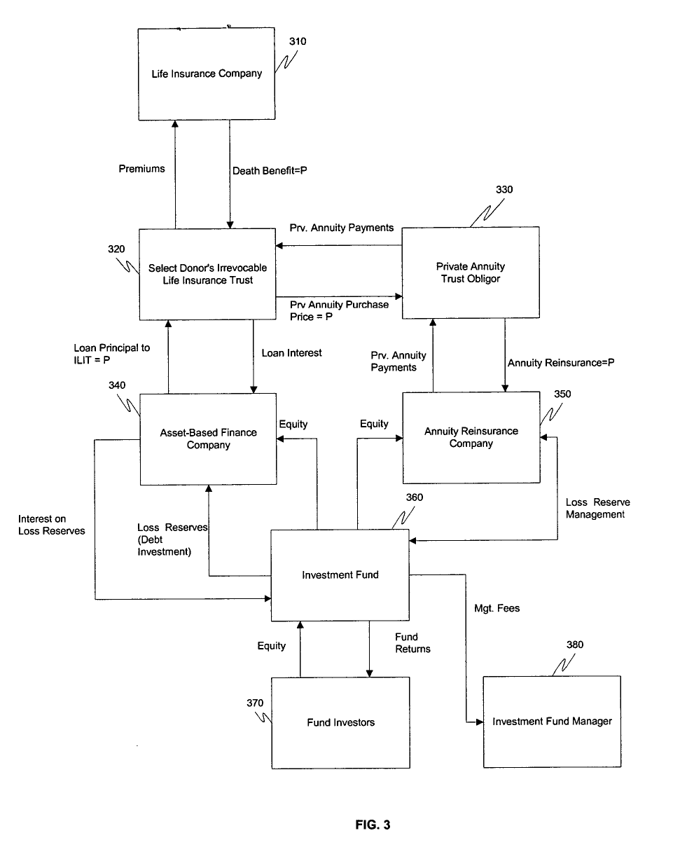

In an alternative embodiment of investor financing of insurance for select donors and their respective beneficiaries, FIG. 3 illustrates a system and method in which a private annuity and a mortality linked loan are used to finance the select donor's insurance trust. FIG. 3 also illustrates from a different point of view, a system and method in which an annuity, such as a private annuity, is purchased with a loan, such as a mortality-linked loan, and the loan is secured or collateralized with the life insurance policies of select donors. Annuity payments are used by the insurance trust to finance the loan and the life insurance policies. Upon death of a select donor, a first portion of the proceeds or death benefit of the life insurance policy is allocated to the loan, and a second portion of the proceeds or death benefit is allocated for donation to the beneficiary. The beneficiary can be selected or designated by the donor or the life insurance trust, and can be an individual, or a for-profit or nonprofit entity or institution.

Referring to FIG. 3, the system contains a life insurance 310, the select donor's insurance trust 320, a private annuity trust obligor 330, an asset-based finance company 340, an annuity reinsurance company 350, an investment fund 360, fund investors 370, and investment fund manager 380. In contrast to the embodiment illustrated in FIGS. 1 and 2, in which an endowment investment fund 160 makes a direct investment into the select donor's 120 insurance trust 150, the system and method of FIG. 3 has a lending institution or asset-based finance company 340 make a loan on the life insurance policy, for a principal amount equal to the amount of the insurance death benefit to the select donor's life insurance trust 320. The loan agreement provides for a collateral schedule whereby the finance company 340 takes a collateral assignment in the assets of the life insurance trust 320, including any death benefits paid under any insurance policies. The collateral schedule may specify, for example, that 80% of specified insurance policies be used to collateralize the loan made by the finance company 340 to the insurance trust 320 for the first 5 years. After 5 years, for example, the collateral required and assigned may increase to 90% or higher. As part of the loan agreement between the insurance trust 320 and the asset-based finance company 340 the insurance trust 320 agrees to make periodic interest payments (e.g., annually) to the finance company 340.

The life insurance trust 320 uses the loan proceeds from asset-based finance company 340 to purchase a private annuity on the life of the select donor (shown as 120 in FIG. 1) from a private annuity trust obligor 330. A private annuity trust obligor 330 is a trust which promises to make annuity payments to an annuitant usually in exchange for a lump sum consideration of cash or other assets. The arrangement is referred to as a private annuity. The annuity is “private” as distinguished from annuities sold by life insurance companies since the entity issuing the annuity is not usually in the business of selling large amounts of annuity contracts. The private annuity trust obligor 330 promises to make periodic payments (e.g., annual) to the select donor's life insurance trust 320 as long as the select donor is alive, in exchange for a lump sum consideration. In this embodiment, the purchase price is equal to the loan principal amount which the finance company 340 loaned to the insurance trust 320. As part of the previously mentioned loan agreement between the asset-based finance company 340 and the select donor's insurance trust 320, the insurance trust 320 uses the annuity payments received from the private annuity trust obligor 330 to both pay the interest to the asset-based finance company 340 and also to purchase a term, whole, universal, universal variable or other life insurance policy on the life of the select donor with death benefit equal to the loan amount from the asset-based finance company 340. The life insurance company 310 receives the premiums from the select donor insurance trust 320 and pays the death benefit to the select donor insurance trust 320 upon the death of the select donor. As indicated above, a portion of the death benefit may have been assigned to collateralize the loan from the asset-based finance company 340 to the insurance trust 320, e.g., 90%. The remainder of the death benefit is paid to the beneficiary of the select donor's choice, such as the university or college from which the select donor graduated (shown as 170 in FIG. 1). Other beneficiaries may receive the balance of such death benefits.

In this embodiment, the private annuity trust obligor 330 will desire to insure the risk of the annuity on the life of the select donor with an annuity reinsurance company 350. The private annuity trust obligor 330 will purchase reinsurance with a lump sum, which can be equal to the fair cost of the annuity on the life of the select donor, and in exchange will receive the annuity payments from the annuity reinsurance company 350 which the private annuity trust obligor 330 has promised to the select donor's insurance trust 320.

Annuity reinsurance company 350 will then have assets equal to the purchase prices of all of the annuities it has reinsured from all respective private annuity trust obligors 330 . These assets can be invested in an investment fund 360. The annuity reinsurance company 350 will receive a rate of return on its invested assets and will be able to draw upon its investment account with investment fund 360 in order to make the promised annuity reinsurance payments to the private annuity trust obligor 330. The annuity reinsurance company 350 will also use the investment fund 360 to manage the loss reserves on the annuities it has reinsured. The investment fund 360, in turn, may invest the interest on the loss reserves and/or invest the loss reserves as a debt investment in the annuity-based finance company 340.

Additionally, investment fund 360 receives equity investment from fund investors 370. The investment fund 360 may be a for-profit investment fund (as opposed to the nonprofit endowment investment fund 160 illustrated in FIG. 1). The investors, can be university or college endowment investment funds. Investment fund 360 is managed by investment fund manager 380 in exchange for fund management fees. The investment fund manager 380 oversees all of the investments of the investment fund 360, and monitors them for adequacy of return given the amount of risk entailed by the fund's investments.

In this embodiment, the investment fund 360 may make loans or other debt investments or equity investments in the asset-based finance company 340 so that the asset-based finance company 340 then has capital to make additional loans to additional select donor insurance trusts in order to finance additional donor insurance policies. The investment fund 360 will receive a rate of return on its investment in the asset-based finance company 340. Similarly, the investment fund 360 may invest (debt or equity) in the annuity reinsurance company 350, in addition to managing the loss reserves from the annuity reinsurance company 350.

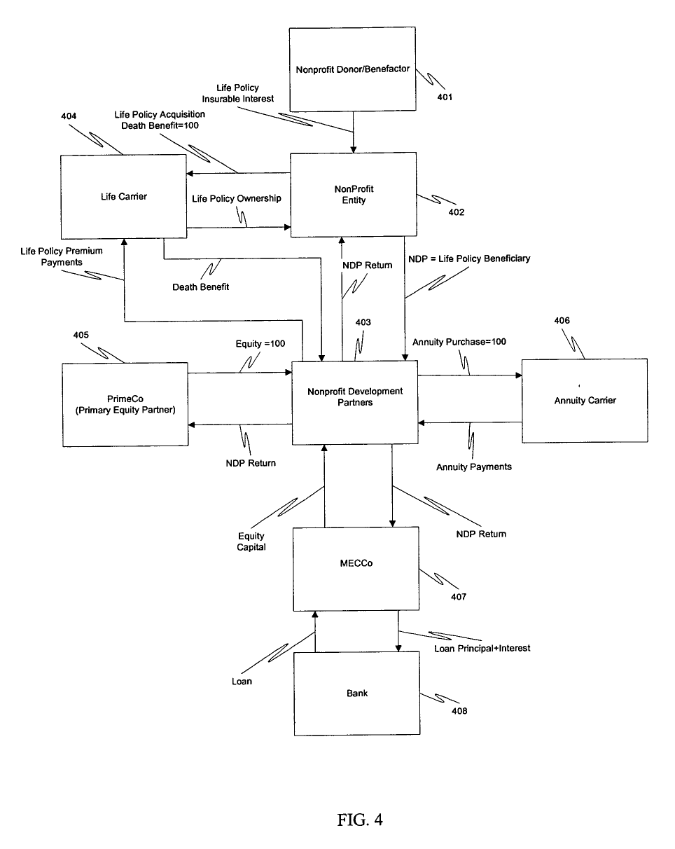

In another embodiment, as illustrated in FIG. 4, a system and method are presented for enabling and facilitating donations of life insurance and annuity proceeds to nonprofit entities such as university/college gift programs. In this embodiment, an insured benefactor 401 of a nonprofit entity 402 provides consent to the nonprofit entity 402 to procure a life insurance contract on the life of the benefactor. Under the law of many of the states in the United States, a nonprofit entity 402 has an insurable interest in such a donor or insured benefactor who provides consent for the nonprofit entity to purchase, own, or become beneficiary on a life insurance policy, notwithstanding the absence of any other insurable interest. For example, the Virginia Insurance Code, section 38-2-301 states:

“In the case of an organization described in § 501 (c) of the Internal Revenue Code, the lawful and substantial economic interest required in subdivision 2 of this subsection shall be deemed to exist where (i) the insured or proposed insured has either assigned all or part of his ownership rights in a policy or contract to such an organization or has executed a written consent to the issuance of a policy or contract to such organization and (ii) such organization is named in the policy or contract as owner or as beneficiary.”

Nearly every state has a similar provision to that of Virginia. Under the Virginia law, and the laws of many other states, the nonprofit entity is required to be either the owner, beneficiary, or purchaser of the policy. Referring again to FIG. 4, the nonprofit entity 402 is named as owner of the policy after purchasing it from Life Carrier 404, a life insurance company. The type of life insurance policy purchased from nonprofit entity 402 from life carrier 404 will be a universal life insurance policy, either fixed or variable. The policy in other embodiments, however, may be term, variable, whole, or other type of life insurance policy.

After being named as owner of the policy (as sanctioned, for example, under the Virginia law above), nonprofit entity 402 assigns its beneficial interest in the life insurance policy to a partnership, limited liability corporation, a C corporation, or other similar entity 403 which is referred to as Nonprofit Development Partners in FIG. 4. The Nonprofit Development Partners (“NDP”) 403 provides the funding for the premiums for the purchased life insurance policy. Since life insurance premiums are option payments (as opposed to a required payment), with the option of receiving the death benefit being revoked upon the cessation of the premium payments, the NDP 403 does not assume liability in its accounts by providing the funding for covering the premiums. In this sense, the NDP 403 can be regarded as receiving an option or opportunity to maintain the life insurance policy (as opposed to an outright obligation), preserving the ability for the NDP 403 to enjoy the beneficial tax treatment of the death benefit, as more fully set forth below.

In exchange for making NDP 403 an irrevocable or revocable beneficiary of the life insurance policy purchased from life carrier 404, the nonprofit entity 402 receives an equity or similar investment interest in NDP 403, which will pay the nonprofit entity 402 an economic return or stream of charitable contributions. In one embodiment, the death benefit received by NDP 403 is received free from ordinary income tax under section 101(a) of the Internal Revenue Code. NDP 403 is a partnership or limited liability company which receives the assignment of the death benefit from the Nonprofit Entity 402 in exchange for a partnership interest owned by Nonprofit Entity 402. Such a transaction is income tax free. Furthermore, in such a tax free transaction, the basis for tax purposes of NDP 403 in the life insurance policy is the same as the basis of Nonprofit Entity 402 prior to the assignment, i.e., the basis is a carryover basis, or is “carried over” from the Nonprofit Entity 402 to the partnership NDP 403. Under IRC section 101(a)(2)(A) the entire death benefit of a life insurance contract remains excluded from gross income notwithstanding a transfer for value “if such contract or interest therein has a basis for determining gain or loss in the hands of a transferee determined in whole or in part by reference to such basis of such contract or interest therein in the hands of the transferor .” This exception to the so-called “transfer for value” rule retaining the tax-free nature of the death benefit is satisfied in the arrangement of FIG. 4. In another embodiment, the Nonprofit Benefactor (“insured benefactor”) 401, who is the insured in the life insurance policy, may be made a partner of NDP 403. In such an embodiment the death benefit will also retain its exclusion from gross income notwithstanding the assignment of beneficial interest in the life policy to NDP 403 by Nonprofit Entity 402, under IRC Section 101(a)(2)(B) which states that “if such transfer is to the insured, to a partner of the insured, to a partnership in which the insured is a partner, or to a corporation in which the insured is a shareholder or officer.”

In addition to the Nonprofit Entity 402, the NDP 403 has at least two other types and classes of investors in this embodiment. One such investor is termed the Primary Equity Partner, or PrimeCo 405 of FIG. 4. PrimeCo 405 may be a nonprofit or charitable equity investor (entity or person), or a taxable, for-profit equity investor. PrimeCo 405 may interested in making an investment in NDP for the purposes of securing an attractive economic return. Alternatively, PrimeCo 405 may be interested in benefiting the nonprofit entity 402, as well as making an investment with an attractive economic return. In the latter case, PrimeCo 405 can be said to be interested in making a “socially responsible investment.” In any event, since PrimeCo's investment results in cashflows going to a nonprofit entity irrespective of its motivations, PrimeCo 405 can be described as a “financial benefactor” or an investor in the NDP 403, which is the “financial benefactor” of the nonprofit entity 402. The socially responsible investment of FIG. 4 is greatly superior to that of known socially responsible investment methods in the prior art, whereby certain equity securities are eschewed by portfolio managers based upon noneconomic criteria such as involvement in the tobacco industry, gambling industry, anti-labor union policies, and so forth. In the socially responsible investment of the present invention, the returns to PrimeCo are largely known and transparent at the time of the investment. Additionally, and importantly, rather than “punish” an industry by avoiding its securities as in the case of tobacco, the investment made by PrimeCo 405 directly benefits the Nonprofit Entity 402, in the form of partnership returns flowing from NDP 403. PrimeCo 405, in this sense, can be considered to be a financial benefactor for Nonprofit Entity 402, or a financial benefactor of NDP 403, which is a financial benefactor for Nonprofit Entity 402. Importantly, no matter what the motivations of PrimeCo 405 in committing capital to NDP 403, a significant result of such a commitment of capital by PrimeCo 405 is that the Nonprofit Entity 402, benefits in the form of substantial and recurring cashflow distributions from NDP 403.

The investment from PrimeCo 405 into Nonprofit Development Partners 403, can be used to purchase an annuity, such as, for example, a Single Premium Immediate Annuity (SPIA) from a life insurance company which underwrites such annuities (“Annuity Carrier”) 406. The annuity can be offered up as collateral for debt financing incurred for maintaining the life insurance policy. A portion of the annuity payments can be allocated to paying premiums on the life insurance policy. Alternatively, in this embodiment, an annuity is purchased to provide cashflows with a favorable rate of return to the NDP 403, part of which can be allocated to the nonprofit entity 402. In this embodiment, a life only SPIA is purchased by NDP 403 from Annuity Carrier 406 on the life of the Nonprofit Benefactor 401. SPIA is a type of annuity which pays periodic cashflows to an annuity payee based upon the life of a natural person. NDP 403 is the owner and payee of the life only SPIA while the Nonprofit Benefactor 401 is the measured life upon whose death the periodic cash flows of a life only SPIA cease to be paid. NDP 403 receives periodic cashflows (e.g., monthly) from Annuity Carrier 406, while the Nonprofit Benefactor 401 is alive. For example, as of Sep. 8, 2003, a life only SPIA annuity from an Annuity Carrier 406, provides monthly payments on a 75 year old male which begin one year from the date of paying for the annuity of 10,192.63 per million dollars of annuity purchased. This is equivalent to an annual rate (as a percentage of the purchase price) of approximately 12.23% (by multiplying the monthly payment number by 12 and dividing by the purchase price).

Additionally, the tax treatment of the life only SPIA under the Federal Income Tax Code of Title 26 provides a very favorable economic return for the financial partner, PrimeCo 405, on an after tax basis in this embodiment. Under section 72(u) of Title 26 (hereinafter referred to as the IRC, for “Internal Revenue Code”) and its subsections, an immediate annuity or SPIA held by a non-natural person such as the NDP 403 of FIG. 4 shall be taxed in the same manner as if the annuity were held by a natural person. For life only SPIA's, the tax treatment has two important elements for the purposes of the efficiency of the present invention. First, only a fraction of the annuity payments are taxable while the person upon whose life the annuity is based (“measured life”) is still alive. For example, for the 75 year old example above, this fraction is approximately 30%. So the annuity payments are predominantly tax-free until the life expectancy is reached for the measured life, as determined by IRS tables. Importantly, however, the early cash flows up until life expectancy, those which have more weight in a net present value calculation, are mostly excluded from income tax. Second, the taxation of life only SPIA type annuities provides for a deduction against ordinary income to the extent that the principal or basis of the annuity has not been recovered due to early mortality of the measured life, e.g., the early death of the Nonprofit Benefactor 401.

In the present example of an annuity which pays 12.23% per annum, if the measured life were to die just after the first year's worth of annuity payments were made to NDP 403, then NDP (and, if NDP is a limited liability corporation with pass through taxation, its investors such as PrimeCo 405) would be entitled to a deduction against ordinary income for the 87.77% of the annuity purchase price (or basis) not paid out. Such a deduction, combined with the favorable tax treatment of the exclusion of most of the annuity payments from gross income (through life expectancy), provides a very favorable economic return for the financial partner, PrimeCo 405, on an after tax basis.

In one embodiment, NDP 403 will have other partners or members and may have more than one class of shares to accommodate the multiple partners or members. For example, the Nonprofit Entity 402 may own one class of shares in NDP 403. These shares may give the Nonprofit Entity 402 different rights than the different class of shares owned by, for example, financial partner PrimeCo 405. For example, the returns to NDP 403 come in the form of tax favored annuity payments and an income tax free death benefit (recall the NDP 403 is the beneficiary of the policy owned by Nonprofit Entity 402). In this embodiment, the Nonprofit Entity 402 since it is not an income tax paying entity, would receive those cashflows from NDP 403 which are more subject to income tax, whereas taxable share owners of NDP 403, such as PrimeCo 405, would receive cashflows from NDP 403 which are less subject to income tax.

Due to the systematic and persistent positive difference between crediting rates and short term borrowing rates, it may be advantageous to use borrowed funds to pay the premiums on the fixed UL life insurance policies. Thus, as shown in FIG. 4, NDP 403 could issue another class of shares to MECCo 407, which could be the entity that takes advantage of this difference, on behalf of NDP 403 and the nonprofit entity 402. MECCo 407 can be a limited liability corporation or similar entity organized under state law. MECCo 407 may make a substantial equity investment in NDP 403. The balance sheet of MECCo may include debt as illustrated by borrowings from Bank 408 in FIG. 4. The class of shares owned by MECCo 407 may be preferred shares, providing MECCo 407 with a preferred return over the classes of shares issued to PrimeCo 405 and the nonprofit entity 402. The preferred return on MECCo's shares may be allocated towards payments on the debt on its balance sheet. The class of shares issued to PrimeCo 405 are pari passu with class of shares issued to the nonprofit entity 402, after the preferred shares issued to MECCo 407, and are thus entitled to a portion of distribution from the assets of the NDP 403 after the distribution to MECCo 407.

One purpose of MECCo's investment in a class of shares of NDP 403 is to enhance the returns from life insurance policy for which NDP 403 is beneficiary. The returns may be enhanced by NDP's using the proceeds from the equity investment made by MECCo 407, for example, in the case that the life insurance policy purchased and owned by Nonprofit Entity 402, is a fixed Universal Life insurance (“UL”) policy. In a fixed UL policy, premiums are used to fund the cost of insurance for the death benefit on a periodic basis (e.g., annually) and other policy expenses. Any additional premiums paid into the policy accrue interest at an interest rate termed the “crediting rate.” The crediting rate is typically much higher than short term borrowing rates (e.g., borrowing rates based upon short term LIBOR) since it reflects the long term investment performance of long duration financial assets held by the insurance carrier. Additional premiums that accrue at this long term rate, however, may be withdrawn from the policy at any time much like funds may be withdrawn from a money market account. Thus, any funds that are accruing at the crediting rate will not suffer a market loss should the crediting rate move up since those finds are invested on a daily basis, e.g., they have only a one day or short term duration. Given that the term structure of interest rates is typically upward sloping and that crediting rates in fixed UL policies tend to move with the short end of the curve but reflect the actual rates earned by insurers on longer duration assets, the difference between crediting rates and short term interest rates has generally been positive. Over the last 15 years or so, the average difference has been approximately several hundred basis points. In 2003, the difference has averaged approximately 400 basis points (the approximate average difference, across UL products for different carriers, between crediting rates and 1 year LIBOR rates).

MECCo 407 can be a finance company which borrows from Bank 408 or other lender, and uses these borrowed funds to make an equity investment in NDP 403. The equity investment made by MECCo 407 may entitle it to ownership in a separate and distinct class of equity shares, as described below. The proceeds of the equity invested by MECCo 407 are used by NDP 403 to make premium payments to the Life Carrier 404 into the fixed UL policy. NDP 403 and MECCo 407 may determine that a high ratio of premium dollars to death benefit is advantageous in the sense that the returns of the life insurance policy may be improved due to the difference between crediting rates and borrowing rates from the bank or other lender 408.

The Nonprofit Entity 402 as owner of the policy may request that the Life Carrier apply the Cash Value Accumulation Test (CVAT) pursuant to IRC Section 7702 rather than the Guideline Premium Test of the same section (GPT),for example, at the behest of NDP 403, PrimeCo 405, MECCo 407 or Bank 408. Both tests provide for how life insurance is defined under the IRC. Under the CVAT method, a policy is required to maintain a minimum ratio of death benefit to policy values. Under the GPT method, there is a limit as to the amount of premium that can be paid under a policy in relation to the death benefit, in addition to a requirement to maintain a minimum ratio of death benefit to policy values. The CVAT test typically allows for a larger amount of premiums to be introduced at an earlier point in the policy which is advantageous when MECCo 407 is financing the policy using borrowed funds. In such an embodiment, MECCo's class of equity shares may have cumulative dividend rights of any dividends payable from the annuity cashflows paid by the annuity carrier 406 to NDP 403. MECCo's class of shares may also have liquidation rights to any assets held by NDP 403 which would include, for example, liquidation rights to the cash value in life insurance policies in which NDP has a beneficial interest. Such additional rights may make MECCo 407 a creditworthy borrower in the view of Bank 408 or other similar lender and reduce MECCo's cost of borrowing.

In another embodiment, the returns may be enhanced by NDP's using the proceeds from the equity investment made by MECCo 407, for example, in the case that the life insurance policy purchased and owned by Nonprofit Entity 402, is a Variable Life insurance (“VL”) policy. In a traditional variable life insurance policy, the death benefit and cash surrender values vary according to the investment experience of separate investment accounts of the policy. Thus, the entire reserve of the policy is held in segregated accounts, and is invested by the owner in equities or other investments, such as, for example, common stock funds, bond funds, balanced funds, money market funds, hedge or other funds. A favorable investment experience will result in increasing the amount of insurance. A poor investment experience will result in reducing the amount of insurance, however, never below a floor equal to the original face amount of the insurance policy.

In this embodiment, the Nonprofit Entity 402 holds the VL policy, along with the right to direct the investment of the reserve. The Nonprofit Entity 402 may invest, or the Nonprofit Entity 402 may assign to the NDP 403 the right to invest and direct the investment of the reserve in a segregated hedge fund or other funds, which will increase the amount of insurance according to the rate of return earned on the hedge fund.

Regardless of the type of life insurance policy involved, the returns for all the entities involved may be enhanced, by having NDP 403 or another manager of the system or method capitalize on the different prices of life insurance and annuity products purchased, for example, for the same notional amount, and for the same measured life. For example, for one insured benefactor, the manager may shop around various life insurance carriers and annuity carriers for each life insurance policy/annuity product combination which maximizes the difference between the annuity rate and the expected cost of the life insurance policy. The annuity rate differs from the expected cost of the life insurance policy for many reasons, including the different underwriting philosophies of annuity carriers and life insurance carriers, different mortality judgments, varying market concerns and other factors between competitors of each type of product. An annuity rate differing from the expected cost of the life insurance policy, is equivalent to an annuity carrier providing an annuity with an implied life expectancy of the insured benefactor 401 that differs from the life carrier's implied life expectancy of the same insured benefactor 401. Maximizing this difference will enhance returns for the nonprofit entity 402, NDP 403, PrimeCo 405, MECCo 407, and other persons or entities involved.

In another embodiment, the NDP 403 or the nonprofit entity 402 may be the entity borrowing funds to pay the premiums on the life insurance policies, e.g., such as UL or VL policies, in order to take advantage of the systematic and persistent positive difference between crediting rates and short term borrowing rates, and enhance returns for the nonprofit entity 402, NDP 403 and its investors, e.g., PrimeCo 405. In this case, there is no MECCo 407. Instead of Bank 408 lending an amount to MECCo 407 who provides equity capital to NDP 403, and earns a preferred return from NDP 403 on such funds, at least some of which is used by MECCo as payments on the loan, NDP 403 or the nonprofit entity 402 could borrow money directly from Bank 408.

In the case that the NDP 403 borrows money directly from Bank 408, instead of providing an ownership interest in the NDP to Bank 408, the NDP 403 would then have incurred debt on its balance sheets, and can use a first portion of the annuity payments as repayments on the loan, before distributing portions to its shareholders, including PrimeCo 405 and the nonprofit entity 402. The NDP 403 could also use a portion of the death benefit as repayment on the loan.

In the case that the nonprofit entity 402 borrows money directly from Bank 408, the nonprofit entity 402 would not provide NDP 403 with the opportunity to pay the premiums on the life insurance policy, but the nonprofit entity 402 would pay the premiums on the life insurance policy directly itself. The NDP 403 would receive an assignment of the death benefit of the life insurance policy from the nonprofit entity 402, and would provide the nonprofit entity 402 with a portion of the annuity payments, as part of an overall distribution from assets of the NDP 403, either through the nonprofit entity's ownership interest in the NDP 403 or through other means.

Regardless of which entity is involved in borrowing the funds to cover the life insurance premiums, additional incentives can be provided to the Nonprofit benefactor 401, to encourage their participation in the system. For example, in another embodiment, Nonprofit Benefactor 401, who provides consent for Nonprofit Entity 402, to purchase or own a life insurance policy on his or her life, or who donates the life insurance policy to the Nonprofit Entity 402, may, in consideration for such consent or assignment, be given the opportunity to direct a portion of the economic returns which flow back from NDP 403 to Nonprofit Entity 402. For example, if, in consideration for assigning the beneficial interest in a life insurance policy to NDP 403, the Nonprofit Entity 402 receives $100,000 per annum (on, for example, the assignment of a $10,000,000 death benefit), then the Nonprofit Benefactor 401 may be given the opportunity to direct some portion of the $100,000 annually to a charity or charities of his or her choice. The ability to direct such large and recurring annual giving provides incentives for Nonprofit Benefactors 401 to participate in the system and method depicted in FIG. 4. In a further embodiment, each Nonprofit Benefactor 401 who participates in the fundraising method and system depicted in FIG. 4 will receive a DonorCard, which is an affinity debit card issued by debit or credit card agencies. The DonorCard will be the tangible evidence of the Nonprofit Benefactor's participation in the method of fundraising of FIG. 4, and the periodic portions of the cashflows which go from NDP 403 to Nonprofit Entity 402, which the Nonprofit Benefactor 401 may direct to go to his or here own selected charities will be credited to the DonorCard. Thus, the Nonprofit Benefactor 401 may receive $50,000 credited to his DonorCard at the beginning of each year or on each anniversary of his participation in the method and system of fundraising of FIG. 4. The DonorCard credits may only be debited at authorized nonprofit institutions. For example, a Nonprofit Benefactor 401, who has a DonorCard with credits, may use his DonorCard at a charitable dinner benefiting a hospital or may make a phone donation using the card to such charities as United Way or the Red Cross. The DonorCard gives the Nonprofit Benefactor a large measure of control and “ownership” attributes of the portion of annual cashflows which he may direct to charities under the method and system of FIG. 4 while also providing efficient means of completing the charitable transactions.

In addition to or in place of the DonorCard and the Nonprofit Benefactor's ability to direct a portion of the economic returns to a charitable cause of his choice, the Nonprofit Entity 402 may, in consideration for the Nonprofit Benefactor's consent or assignment, offer subsidized or free alternative insurance products to the Nonprofit Benefactor 401, depending, for example, on the age bracket of the Nonprofit Benefactor 401 and the capitalization of the NDP 403. For example, a Nonprofit Benefactor 401 may be offered a free or heavily subsidized, with funds from the NDP 403, a long term care insurance contract in return for permitting the Nonprofit Entity 402 to hold a life insurance policy on his life.

In a further embodiment, the NDP 403 may engage in a variety of capital market's related transactions, including the use of futures, options, asset swaps, and other similar transactions. The goal of such transactions is to provide and overlay the returns of the partnership or limited liability company related to insurance products (life insurance policies and annuities) and bundle them with traditional returns derived from fixed income and equity securities. Such a “portable alpha” strategy treats the returns from the insurance products received by the NDP 403, (whether the NDP is a partnership or limited liability company) as additive to traditional investments, such as an investment in a broadly based stock portfolio. Since the returns derived from the insurance products are uncorrelated to such traditional investments, the returns derived therefrom are commonly referred to using the nomenclature “alpha.” Thus, the returns from the insurance products can be added or ported to other traditional asset classes, thereby creating financial returns which can be described as “portable alpha.”

In a further embodiment, the NDP 403 or the Nonprofit Entity 402 may issue tax preferred securities in the NDP 403, thus backed by the above described assets. The Nonprofit entity 402, e.g., a university or similar institution, can issue securities such as bonds or debentures with a high credit rating (e.g., AA or AAA credit rating), but at a lower rate than the return earned on the investment in the annuity and the return earned on the investment in the life insurance policy. The difference between the rate on the bond or debenture and the rate of return on the annuity and the life insurance policy is allocated to the Nonprofit Entity 402. The funds raised with the issued bonds and debentures can be used in whole or in part towards the purchase of the annuity and/or the maintenance of the life insurance policy. The securities can be referred to as “PLEDGES,” or Pooled Life Endowment Donation Guaranteed Earnings Securities.

In one example, a university issues 100 million of these PLEDGES, which are the investor partnership interests from FIG. 4. The university offers a rate that is lower than the rate earned on the investments in the annuity and the life insurance policy by the NDP 403. The offered rate may be slightly better than comparable tax-favored investments such as municipal bonds. So, for example, the university might issue 100 million of these securities at a 5% fixed coupon with a AAA guarantee, purchased or provided by the university, which provides a higher return and credit rating than many municipal bonds. Now, since the life insurance and annuity contracts have a minimum yield of 8% currently, an expected yield of 15%, and may yield 20% or higher, the university will make the difference between this higher rate and the rate it guarantees to investors. For example, if the life insurance and annuity contracts end up returning only 8%, the university will make 3% on $100 million for an average of 8 years, if, for example, the average age of insured benefactor is 75, which is $3 million per year for 8 years, for a total of $24 million. If the life insurance and annuity contracts end up returning the expected rate of return of 15%, the university could receive 10% or $10 million a year for an average of 8 years or $80 million. The university could end up issuing (through its nonprofit development partner 403) tax preferred securities that are more desirable than similar investments in the marketplace. These securities, backed by the “insured annuity” structure assets in the NDP 403, offer a higher credit rating and a higher rate of return than most municipal bonds.

These “insured annuity” structured assets return much more than what the rate guaranteed by the university to the buyers of these securities. The remainder can go to the university to fund buildings, professorships, etc. As a further example, a particular investor may have $1 million and have philanthropic intent. The investor may currently have this $1 million invested in 10 year municipal bonds currently yielding 3.5%. The university offers an investment of the same maturity that will pay the investor 5% on his $1 million, and has a high credit quality return of closer to 15%, because of the “insured annuity” asset structure backing the security. The university retains the spread of $100,000 per annum or $1 million total. Thus, the investor being recognized for having given $1 million to the university, has also used the gift as an investment more prudent to the other similar available instruments in the market place.

The returns on these “insured annuity” structured assets are enhanced, as described above, if NDP or the nonprofit entity shops around for life insurance policies and annuities from different carriers which maximize the annuity rate and minimize the expected cost of the life insurance policy.

Additionally, in other embodiments, there can be more than one insured benefactor 401, as well as more than one life insurance policy and annuity. The NDP 403 can select desirable candidates for donating life insurance policies or consenting the nonprofit entity to purchase the life insurance policies from a pool of possible candidates (as set forth above with reference to FIGS. 1 to 3), and then shop around for annuities and life insurance policies for each insured benefactor which maximizes the annuity rates and minimizes the expected cost of the life insurance policy. The NDP then acquires a pool of assigned death benefits on a variety of life insurance policies, and purchase a pool of annuities, and provide distributions to one or more nonprofit entities 402. There may be, for example, an “insured annuity” on each insured benefactor 401, which is an annuity backed or coupled with a life insurance policy on the life of one benefactor. The notional or face value of each of the instruments may be equal to one another, e.g., the life insurance policy death benefits may be equal to the face value of the annuity, because they are priced differently from one another. In any of the embodiments in this application, the face value of the purchased annuity may be greater than or less than the value of the life insurance policy, varying the amount of leverage of the portfolio of assets, and the returns (and the risk).

In another embodiment, each of one or more nonprofit entities 402 may acquire a collection of life insurance policies for a pool of insured benefactors, and assign the death benefits of such policies to the NDP 403, in exchange for a right to a distribution from the assets of the NDP 403. The NDP 403 may issue one class of shares to the nonprofit entity 402, another class of shares to raise the capital to cover the purchases of annuities on all the insured benefactors 401, and a third class of shares to raise the capital to cover the maintenance of all the life insurance policies.

Alternatively, a nonprofit entity 402 may have life insurance policies insuring the lives of two or more insured benefactors 401, with different death benefit provisions. For example, the nonprofit entity 402 may be the owner of a joint life insurance policy (such as a joint universal life or variable insurance policy) covering the lives of two insured benefactors 401, which generally provide for the benefit payment upon the death of the first-to-die insured benefactor, otherwise referred to as the first death. The nonprofit entity 402 may be the owner of survivorship whole life, term, variable or universal life insurance policies which also cover the lives of two insured benefactors 401, but generally pays the benefits upon the second death. In addition, there may be other life insurance products or policies providing different benefit payment provisions which may be available to the nonprofit entity 402.

Similarly, the NDP 403 may purchase annuities on the lives of two or more insured benefactors 401, with different annuity payment provisions. For example, the NDP 403 may purchase a joint life annuity, where the benefit payments (the annuity payments) continue throughout the joint lifetime of two insured benefactors 401, but terminates upon the first death. Other annuity instruments offer additional investment opportunities for the NDP 403, including the survivorship annuity and the joint and survivorship annuity, as well as other annuity products. The joint and survivorship annuity (sometimes referred to as the joint life and survivorship annuity) provides annuity payments during the period of the joint lives of two insured benefactors 401, and after the first death, continues annuity payments until the second death. Survivorship annuities (sometimes referred to as reversionary annuities), provide annuity payments after the first death until the second death.

The annuities and life insurance policies can be coupled with each other, forming “insured annuities” on the same lives of the same benefactors, such that one instrument provides payment when the other instrument ceases to provide payments to the NDP 403. The annuity may be provided by an annuity carrier which can be different from the life insurance carrier issuing the life insurance policy. In one example of an insured annuity, a joint life annuity might be coupled with a joint life insurance policy on the lives of two insured benefactors 401. The joint life annuity ceases providing payments until the first death, and the joint life insurance policy provides payment of the death benefit upon the same first death. A joint life and survivor annuity might be coupled with a survivor life insurance policy, the first providing payments until the second death, the second providing payment of the death benefit upon the same second death. Other combinations are possible, including coupling a survivor life insurance policy on two insured benefactors 401 with two annuities, one on the life of each benefactor. Additional combinations of life insurance and annuity products may be used, to enhance the returns to the investors and the payments for the nonprofit entity 402.

In another embodiment, the NDP 403 may, as part of a hedging strategy, accept death benefits on life insurance policies on one group of benefactors, and purchase annuities on the lives of another group of benefactors. The cohort of life insurance benefactors can have similar underwriting characteristics as the cohort annuity benefactors.

The returns on all of the above described combinations and strategies can be further enhanced if life insurance policies and annuities are selected which, over the entire portfolio of both products, maximize annuity rates and minimize the expected cost of life insurance policies.

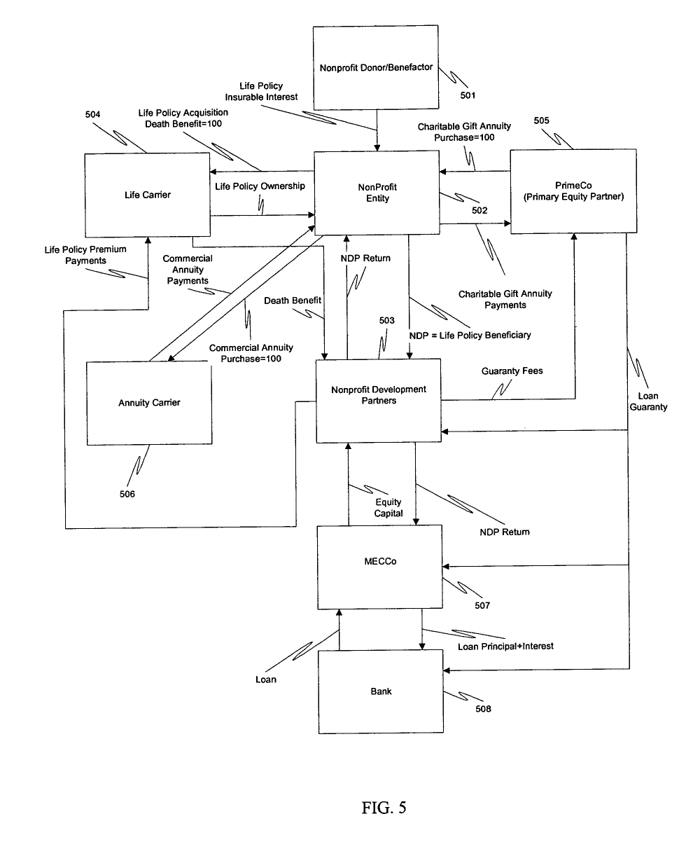

Other embodiments, such as the embodiments illustrated in FIG. 5, provide other structures of enabling and facilitating donations to a nonprofit entity which further isolate the participation of the equity investor, e.g., PrimeCo 505, from the benefits under the life insurance policy. These other structures may be more favorable and provide further assurances in states having insurance and tax law requirements which differ from the insurance and tax law requirements in Virginia (discussed above). Thus, each of such other structures provide different means to provide the same financing needed to cover the payment of the life insurance premiums and the annuity purchase, which in turn generates the consideration provided to the nonprofit entity, the return to the equity investors, and the repayment of loan principal and interest to the debt financiers. These amounts are generated, inter alia, due to the difference between the crediting rate and short term borrowing rates on the life insurance policy, the different pricing mechanisms of the annuities as opposed to the life insurance policies and the different tax treatments of each cashflow in the structure. The above is true, regardless of whether the notional or face value of each of the instruments in the structure are equal to one another, as illustrated in FIG. 5 or vary from one another. For example, as illustrated in FIG. 5, the life insurance policy death benefits may be set at an equal value to the face value of the annuities (“Life Policy Acquisition Death Benefit=100”, “Charitable Gift Annuity Purchase=100,” Commercial Annuity Purchase=100”), while still enhancing the returns for everyone, since each of these instruments are priced differently, as described above with reference to FIG. 4.

In one such other embodiment, illustrated in FIG. 5, NDP 503 still receives an interest in the death benefit under the life insurance policy from the nonprofit entity 502, and NDP 503 still provides consideration to the nonprofit entity 502, such as an NDP return, or other distribution from NDP's assets by providing the nonprofit entity 502 with an ownership interest in NDP 503, or through other means entitling the nonprofit entity 502 with consideration from NDP 503. Unlike some of the prior embodiments, NDP 503 does not purchase the annuity.

The nonprofit entity 502 may assign the death benefit outright to NDP 503. However, some states require, unlike Virginia (discussed above), that the nonprofit entity 502 be both owner and beneficiary of a life insurance policy in order to have a sufficient insurable interest (even after the initial acquisition of the policy), while permitting the nonprofit entity 502 to incur debt financing on its balance sheets. In such states, the assignment may be characterized as a collateral assignment, provided to the extent that the debt financing (through debt instruments or otherwise) is secured by a portion or all of the death benefit under the life insurance policy.

Nonetheless, in order to isolate the equity investors further from the benefits under the life insurance policy in this embodiment, the equity investors, e.g., PrimeCo 505 as illustrated in FIG. 5, are no longer provided with an ownership interest in NDP 503. In the case that NDP 503 is a partnership, PrimeCo 505 is no longer a partner in the NDP 503. In the case that NDP 503 is a limited liability corporation or other type of entity, PrimeCo 505 no longer owns a class of shares in NDP 503.

In this embodiment, equity investors, such as PrimeCo 505 (which may be nonprofit or taxable for-profit investors), participate in the structure through the direct purchase of an annuity, and by subordinating PrimeCo's interest in the annuity payments to the interests of the nonprofit entity 502, NDP 503, MECCo 507 (or other preferred investors), and/or Bank 508, or otherwise offering up the annuity payments as a loan guaranty on the debt financing, both of which are sometimes referred to as providing a collateral assignment to the nonprofit entity 502, NDP 503, MECCo 507 and/or Bank 508 in the annuity cashflows provided to PrimeCo 505. Such a guaranty or assignment to the nonprofit entity 502, NDP 503, MECCo 507 and/or Bank 508, enables the borrowing entity (whether the borrowing entity is the nonprofit entity 502, NDP 503 and/or MECCo 507) secure more favorable terms from Bank 508 on the debt financing, which is later used to generate funds to pay the life insurance premiums. The annuity may be based on the measured life of the insured benefactor 501 (same life used for the life insurance policy) under an “insured annuity” or based on some other measured time period, such as the measured life of another person, as described above with respect to joint policies, annuities and separate cohorts of persons for life insurance and annuity contracts.

In this embodiment, PrimeCo 505 earns a return on its equity investments through the guaranty fees or other consideration received from NDP 503 for the interest subordination or offered guaranty, and through the portion of annuity payments received from the nonprofit entity 502, if any, which are not retained by the nonprofit entity 502, or provided to NDP 503, MECCo 507 and/or Bank 508, as opposed to prior embodiments (in which PrimeCo 405 earned a return through distributions from assets of NDP 403).

Thus, instead of having an ownership interest in NDP 503, PrimeCo 505 essentially becomes a contractual guarantor of the loan agreements, which Bank 508 has with MECCo 507, and/or with NDP 503, in the event that NDP 503 borrows funds directly from Bank 508, and/or with the nonprofit entity 502, in the event that the nonprofit entity 502 borrows funds directly from Bank 508. The contractual guaranty from PrimeCo 505 enables MECCo 507, NDP 503 and/or the nonprofit entity 502 to acquire debt financing from Bank 508 on more favorable terms (for example, a lower borrowing rate), which enables them to earn a higher net return on the cash value of the life insurance policy.

The guaranty fee or other consideration provided to PrimeCo 505 may be determined, e.g., as an annual percentage of the loan amount or otherwise so that such consideration compounded over the life of the annuity provides PrimeCo 505 (and its investors) with a desired rate of return on the equity investment. The desired rate of return on the equity investment may be determined as a function of the return that PrimeCo 405 would have earned in prior embodiments, e.g., from a portion of distributions by NDP 403 from its assets and a portion of the death benefit allocated by NDP 403 to PrimeCo 405. This consideration may be paid by NDP 503, MECCo 505 and/or Bank 508, out of the cash value of the life insurance policy(ies) held by NDP 503, and/or in arrears out of the death benefits (at the death of each insured benefactor 501), or through assignment of all or part of a death benefit held beneficially by NDP 503. This consideration may be paid in a lump sum, over a period of time, or otherwise periodically, e.g., on an annual basis to PrimeCo 505.

Unlike Virginia and many other states, there are a few states in the U.S. requiring the absence of equity investors with an insurable interest in the insured benefactors. The purpose of such legislation is often cited as preventing an equity investor from being in a position to profit from an early death of an insured individual. Although the equity investors in the embodiments presented herein (including those illustrated in FIGS. 4 and 5) profit or earn a greater return from a prolonged life of the insured benefactor, and stand to earn a lower return or realize a loss upon the early death of the insured benefactor, claims may be brought in such few states against the equity investors receiving any portion of death benefits from the life insurance policies.

Although it is unclear under the laws of such few states, whether the ownership interest PrimeCo 405 has in NDP 403 in prior embodiments could be regarded as providing PrimeCo 405 with an insurable interest in the insured benefactors 401, in the embodiments illustrated in FIG. 5, PrimeCo 505 (and other equity investors) as a contractual loan guarantor (and not part owner) for NDP 503, MECCo 505, and/or Bank 508, lacks any insurable interest in the insured benefactors 501. Even if the consideration to PrimeCo 505 for the loan guaranty is paid in arrears out of the death benefits, such consideration is provided for guaranteeing the loan or other debt financing covering the policy premiums, and not out of an ownership interest in any entity claiming an insurable interest in the insured benefactors 501. Thus PrimeCo 505 and other equity investors are provided under this embodiment with further assurances of protection against the above-described claims opposing their receipt of payments from death benefits. As a contractual loan guarantor, PrimeCo 505 may be viewed as a creditor (as opposed to equity investor), entitling PrimeCo 505 to a collateral assignment in the death benefits to secure PrimeCo's guarantee of the loan or debt financing. The collateral assignment may be valued as the guaranty fees or other consideration plus interest compounded thereon.

However, in this embodiment, PrimeCo 505 may be taxed for the loan guaranty consideration that it receives from NDP 503, MECCo 505, and/or Bank 508, as opposed to the portion of the distribution provided to PrimeCo 405 under prior embodiments through PrimeCo's ownership interest in NDP 403. Regardless of whether the loan guarantee consideration is taxed, PrimeCo 505 can enhance its post-tax returns by purchasing a charitable gift annuity from the nonprofit entity 503, as opposed to directly purchasing an annuity from annuity carrier 506. The nonprofit entity 502 can use the capital provided by PrimeCo 505 to purchase a commercial or other annuity from annuity carrier 506 for the same nominal amount as the charitable gift annuity purchased by PrimeCo 505. The commercial annuity payments may be provided to the nonprofit entity 502 for the same measured life or otherwise for the same duration as the charitable gift annuity payments to PrimeCo 505. The nonprofit entity 502 can use a portion of the commercial annuity payments that it receives to cover the charitable gift annuity payments that it makes to PrimeCo 505. The annuity purchased by PrimeCo 505 qualifies as a charitable gift annuity and provides a tax deduction to PrimeCo 505 (or the other equity investors who provide the capital for the purchase) under Sections 501(m)(5) and 514(c)(5) in the Internal Revenue Code (26 U.S.C. Sections 501(m)(5) and 514(c)(5) 1986), if that the nonprofit entity retains at least some portion, for example 10% of the commercial annuity payments for its own use. Thus, PrimeCo cannot receive more than 90% of the return that it would otherwise be able to earn on the annuity, in order to qualify its capital investment as a tax-deductible nonprofit or charitable contribution.

In addition to providing a tax deduction to PrimeCo 505, the charitable gift annuity makes it easier for the nonprofit entity 502 to qualify and obtain nonprofit status under Section 501(c)(3) in the Internal Revenue Code (26 U.S.C. Section 501(c)(3) 1986), by providing the nonprofit entity 502 with a method of funding that is permissible and qualified as charitable funding for the nonprofit entity 502.

However, the nonprofit entity 502 need not reinsure the charitable annuities with commercial annuities on a case by case basis. Rather, the nonprofit entity 502, can invest the funds for the charitable gift annuity purchases from PrimeCo 505, and use the return from such investments to pay the annuity payment obligations to PrimeCo 505 under the charitable gift annuities. If the nonprofit entity 502 engages in its own investments, it would need to ensure compliance with all relevant state and Federal laws pertaining to the management of charitable gift annuity programs, while bearing the risk that the returns on their investments may not be sufficient to cover their charitable gift annuity payment obligations.

Aspects of the various embodiments illustrated in FIGS. 1 through 5, and described above, can be combined with each other, and tailored to maximize annuity returns and minimize expected life insurance policy costs, while fitting the confines of the various Federal and state insurance and tax laws as well as other relevant laws and regulations, as such laws vary from state to state, and as they evolve and change over time. The various combinations are possible in order to provide the greatest return to the participants involved, including the nonprofit entity or charitable cause. Various other combinations are also possible, provided that the nonprofit entity receives some consideration in exchange for the assignment of death benefits, and can provide another investor or entity with the opportunity or option to maintain the life insurance policies. The management of a nonprofit development partner or other organization, including a management organization within a nonprofit entity or director of a charitable cause, may design the life insurance strategy that best fits the requirements of its state, and the various insured and financial benefactors involved.

In the embodiments shown in FIGS. 1 to 5, the superior risk adjusted investment returns received by the EIF of the first embodiment or the investment fund of the second embodiment or the financial partner of the third embodiment, or the financial benefactor or NDP and its investors in the further embodiments, derive from the unique portfolio management techniques and portfolio composition characteristics of the present invention. In particular, these techniques and characteristics include, but are not limited to:

(1) Lapse Rate Arbitrage Opportunities: The pricing of insurance policies inherently involves the pooling of risks which are not identical. Underwriting risk classification aims to make these risks within a class as homogenous as possible so that each risk class can be discriminated by price. Nevertheless, there inevitably remains cross-subsidies in insurance, whether from good risk to bad risk (adverse selection) or intentional use of subsidies to price policies in order to attract additional underwriting business. For example, insurance companies may subsidize the underwriting of older insureds who desire large policies at substantial premiums in order to attract the business away from competitors. One mechanism of subsidy is to provide lower pricing to a group of insureds based upon an estimate that a percentage of the group will lapse their policies over time, i.e., that premiums will be paid for some number of months or years, but that, prior to death, the policy will be surrendered or lapsed. When a policy lapses, the insured pays no further premiums, forfeits all future benefits under the policy including the death benefit, and may obtain a cash surrender value from the company. Typically, the insurance company will have obtained the use of the premium funds from lapsed policies at very low cost since the insurer will never be obligated to pay death benefits on the lapsed policies. Some insurers can then pass on the savings from lapsed policies to the group as a whole in terms of lower premium charges. In each of the various embodiments of this invention, the group of select donors participating will have life insurance policies that are funded to maturity, i.e., no donor policies will be surrendered or lapsed. These policies as a group take advantage of the lapse rate subsidy provided to the group as a whole which increased the returns to the EIF of FIG. 1 or the investment fund of FIG. 3, or the financial benefactors of FIGS. 4 and 5, and the investors in each of the embodiments.

(2) Leverage on Invested Assets: Another source of economic benefit to the methods and systems of the present invention is the natural increase in returns due to financing future premium payments on a portfolio of select donor life insurance with the death benefits from select donors in the portfolio that have died. Early death benefits therefore provide an additional form of continuing financing for ongoing premium obligations for select donors in the program who are still alive. The additional financing in the form of death benefits boosts the returns to the capital invested by the EIF of FIG. 1 or the investment fund making loans to purchase annuities which fund the life insurance policies in FIG. 3.

(3) Real and Financial Policy Options: Many types of life insurance policies, in particular universal life insurance, have a variety of embedded contract terms which can be optimally used by the owner of the policy to increase the expected value of the policy to the owner or the entity financing the policy. For example, most universal life policies provide for minimum interest rates at which account values are credited. These typically exceed short term interest rates in the capital markets and can be used by the owner of the policy in a variety of ways to increase returns on the policy. For example, the owner may use the floor or minimum interest rate provided by the policy by investing excess finds in the policy and then selling an interest rate floor in the capital markets, such as eurodollar floor in the Chicago Mercantile Exchange. As an additional example, most universal life policies allow premium payments on a flexible schedule as long as monthly mortality deductions are covered. Typically, the monthly mortality charges are quite low in the early years and then grow in the later years. However, the mortality charges are typically lower than the annual death rates in the later years. A greater return on capital is achieved by paying the minimum mortality charges in the earlier years and more than a flat premium in the later years. Other types of options embedded in universal life and other life insurance policies can be optimally managed in order to extract additional returns on investor capital.

(4) Annuity versus Life Insurance Arbitrage: The embodiment described above, with reference to FIGS. 4 and 5, for example, seeks to capture a possible favorable difference in how mortality risk is priced between annuity carriers, on the one hand, and life insurance carriers, on the other hand. For example, it is not uncommon for this difference to work for the benefit of the fundraising methods and systems of FIGS. 4 and 5 in the following manners.

a. An insured may be just barely healthy enough to receive a standard rating for life insurance by one life insurance carrier (after having possibly been rejected for standard rates by other carriers). At least one annuity carrier simultaneously recognizes the sub-optimal health of the insured and issues the insured a medically underwritten annuity which pays a higher then standard rate. Thus, the insured receives higher annuity payments but pays standard life insurance rates. This difference, compounded over many years, can be very economically significant. As another example, it is possible for an insured to receive a standard risk annuity but yet receive extremely favorable life insurance rates as a preferred or “super-preferred” risk. In this example, the insured receives annuity cashflows which are standard, but only need pay less than standard insurance premiums to receive the return of capital in the form of the life insurance death benefit.

b. Even in the normal course of underwriting standard life insurance policies and standard annuities, there are annuity vs. life insurance arbitrage opportunities. The annuity and insurance carriers may make different mortality judgments about the same insured, thus offering annuity rates which differ from expected life insurance costs, even for the same notional amount. The difference in annuity rates from expected life insurance costs, is equivalent to an annuity having a different implied life expectancy from the life insurance policy. The difference between the two can be quite favorable, e.g., well above the cost of finds for the respective carriers at their respective credit ratings. By shopping around for various annuities and life insurance products, the manager (whether it is NDP 403 or another entity), maximizes the difference, and enhances the returns for everyone involved. For example, even a difference in 0.5% between the annuity rate and life insurance cost can represent a tremendous economic profit potential for the nonprofit and the financial benefactors.

In the preceding specification, the present invention has been described with reference to specific exemplary embodiments thereof. Although many steps have been conveniently illustrated as described in a sequential manner, it will be appreciated that steps may be reordered or performed in parallel. It will further be evident that various modifications and changes may be made therewith without departing from the broader spirit and scope of the present invention as set forth in the claims that follow. The description and drawings are accordingly to be regarded in an illustrative rather than a restrictive sense.

What is claimed is:

1. A method for enabling donations to a nonprofit entity, comprising the step of:
donating an insurance policy to a nonprofit entity, the nonprofit entity assigning a beneficial interest to a financial benefactor in exchange for a consideration from the financial benefactor, and the nonprofit entity providing the financial benefactor with an opportunity to finance the insurance policy.

2. A method for a nonprofit entity to process donations, comprising the steps of:
receiving consent from a donor to hold an insurance policy insuring the donor;
assigning a beneficial interest under the insurance policy to a financial benefactor;
receiving an ownership interest in the financial benefactor; and
providing the financial benefactor with an opportunity to finance the insurance policy.

3. A method for enabling donations to a nonprofit entity, comprising the steps of:
assigning to another entity a payout of an insurance policy held by the nonprofit entity insuring a donor;
assigning an opportunity to finance the insurance policy to the other entity; and
receiving consideration from the other entity.

4. A method for facilitating donations to a nonprofit entity, comprising the steps of:
receiving a beneficial interest to an insurance policy held by the nonprofit entity, the insurance policy insuring a donor;
receiving an opportunity to maintain the insurance policy in force;
maintaining the insurance policy in force with at least some financing;
providing the nonprofit entity with a right to a distribution from assets including the insurance policy and the financing.

5. A method for enabling donations to a nonprofit entity, comprising the steps of:
financing an insurance policy held by the nonprofit entity, the insurance policy insuring a donor;
providing consideration to the nonprofit entity; and
receiving from the nonprofit entity a right to a payout of the insurance policy.

6. The method according to claim 5, wherein the financing step includes the step of:
financing the insurance policy with funds earning a return from the insurance policy higher than a cost of acquiring the finds.

7. A method for facilitating donations to a nonprofit entity, comprising the steps of:
providing financing to a financial benefactor of the nonprofit entity, a total financing of the financial benefactor including the provided financing, at least part of the total financing being applied to maintaining an insurance policy in force for the nonprofit entity, the nonprofit entity holding an insurance policy insuring a donor, the nonprofit entity assigning a beneficial interest under the insurance policy to the financial benefactor in exchange for a first right to a distribution from assets of the financial benefactor, the assets including a value of the insurance policy to the financial benefactor; and
receiving a respective right to the distribution.

8. A method for enabling donations to a nonprofit entity, comprising the steps of:
receiving an assignment from the nonprofit entity of a death benefit of a life insurance policy held by the nonprofit entity, the life insurance policy insuring a life of a donor;
receiving an opportunity to maintain the life insurance policy;
receiving financing, a total financing including the received financing, at least some of the total financing being allocated to maintain the life insurance policy; and
providing the nonprofit entity with a right to a first portion of a distribution from assets, the assets including a value of the death benefit of the life insurance policy.

9. The method according to claim 8, wherein the receiving financing step includes the step of:
receiving debt financing to maintain the life insurance policy.

10. The method according to claim 8, wherein receiving financing step includes the step of:
receiving financing arising from debt financing to maintain the life insurance policy.

11. The method according to claim 8, wherein the receiving financing step includes the step of:
receiving equity financing to maintain the life insurance policy.

12. The method according to claim 8, wherein the receiving financing step includes the step of:
receiving debt and equity financing to maintain the life insurance policy.

13. The method according to claim 8, wherein the receiving financing step includes the step of:
receiving financing to maintain the life insurance policy from another entity, the other entity incurring debt financing, at least some of the debt financing being applied to provide the financing to maintain the life insurance policy.

14. The method according to claim 8, further comprising the step of:
using at least some of the total financing to pay premiums on the life insurance policy.

15. The method according to claim 14, further comprising the step of:
allocating a second portion of the distribution from the assets as payments on the financing used to pay the premiums on the life insurance policy.

16. The method according to claim 8, further comprising the step of:
acquiring an annuity on the life of the donor to provide annuity payments during the life of the donor.

17. The method according to claim 16, wherein the acquiring step includes the step of:
using at least some of a remaining portion of the total financing to purchase the annuity.

18. The method according to claim 16, wherein providing step includes the step of:
allocating to the nonprofit entity a first portion of the distribution from the assets, the assets including a cash value of the life insurance policy and the annuity payments.

19. The method according to claim 18, further comprising the step of:
providing periodic payments to the nonprofit entity from a first portion of at least one of the cash value of the life insurance policy and the annuity payments.

20. The method according to claim 19, wherein the allocating step includes the step of:
assigning an ownership interest to the nonprofit entity, the ownership interest including an entitlement to the periodic payments.

21. The method according to claim 18, wherein the allocating step includes the step of:
allowing a first distribution from a cash value of the life insurance policy to the nonprofit entity on a periodic basis.

22. The method according to claim 18, wherein the acquiring step includes the steps of:
purchasing a single premium immediate annuity from a life insurance company, providing periodic cash flows based upon the life of the donor, the periodic cash flows being the annuity payments.

23. The method according to claim 18, further comprising the step of:
allocating a second portion of the distribution from the assets as payments on the financing used to purchase the annuity.

24. The method according to claim 23, wherein the step of purchasing the annuity with at least some of the financing, includes the steps of:
using equity financing to purchase the annuity with a lump sum payment.

25. The method according to claim 23, wherein the step of purchasing the annuity with at least some of the financing, includes the step of:
using debt financing to purchase the annuity with a lump sum payment.

26. The method according to claim 23, wherein the step of purchasing the annuity with at least some of the financing, includes the step of:
using debt and equity financing to purchase the annuity with a lump sum payment.

27. The method according to claim 23, further comprising the step of:
using at least some of the total financing to pay premiums on the life insurance policy.

28. The method according to claim 27, further comprising the step of:
allocating a third portion of the distribution from the assets as payments on the financing used to pay the premiums on the life insurance policy.

29. The method according to claim 18, wherein the receiving financing step includes the step of:
accepting financing from at least one source.

30. The method according to claim 29, wherein the using step includes the step of:
purchasing the annuity with at least some of the financing from the at least one source.

31. The method according to claim 29, further comprising the steps of:
accepting one of debt financing, equity financing, and a combination of debt and equity financing from each of the at least one source.

32. The method according to claim 18, wherein the receiving financing step includes the step of:
accepting financing from a primary investor.

33. The method according to claim 32, further comprising the step of:
allocating a second portion of the distribution to the primary investor.

34. The method according to claim 33, wherein the using step includes the step of:
using the financing from the primary investor to purchase the annuity with a lump sum payment.

35. The method according to claim 32, further comprising the step of:
accepting additional financing from a secondary investor.

36. The method according to claim 35, wherein the step of accepting additional financing includes the step of:
accepting additional equity financing from a secondary investor, the secondary investor funding the additional equity financing with debt financing incurred by the secondary investor.

37. The method according to claim 36, further comprising the step of:
allocating an additional portion of the distribution to the secondary investor, at least some of the additional portion being allocated by the secondary investor as payments on the incurred debt financing.

38. The method according to claim 35, further comprising the step of:
allocating an additional portion of the distribution to the secondary investor.

39. The method according to claim 35, further comprising the step of:
using the additional financing from the secondary investor to pay premiums on the life insurance policy.

40. The method according to claim 18, further comprising the step of:
receiving the death benefit of the life insurance policy upon the death of the donor.

41. The method according to claim 18, further comprising the step of:
allocating a portion of the death benefit to a primary investor.

42. The method according to claim 18, further comprising the step of:
allocating a portion of the death benefit to a secondary investor.

43. The method according to claim 18, further comprising the step of:
allocating a portion of the death benefit to the nonprofit entity.

44. The method according to claim 18, wherein the providing step includes the step of:
providing the nonprofit entity with an ownership interest entitling the nonprofit entity to at least the first portion of the distribution.

45. The method according to claim 44, further comprising the step of:
providing a primary investor with an ownership interest entitling the primary investor at least a second portion of the distribution.

46. The method according to claim 45, further comprising the step of:
providing a secondary investor with an ownership interest entitling the secondary to at least a third portion of the distribution.

47. The method according to claim 18, further comprising the step of:
engaging in at least one capital market transaction.

48. The method according to claim 47, further comprising the step of:
bundling a return on the insurance policy and the annuity together with the return on at least one of the capital market transactions.

49. The method according to claim 47, wherein the engaging step includes the step of:
purchasing at least one of a fixed income security, an equity security, a future, an option, and an asset swap.

50. The method according to claim 18, wherein the assignment receiving step includes the step of:
receiving from the nonprofit entity the assignment of the death benefit of a universal life insurance policy held by the nonprofit entity on the life of the donor.

51. The method according to claim 18, wherein the assignment receiving step includes the step of:
receiving from the nonprofit entity the assignment of the death benefit of a term life insurance policy held by the nonprofit entity on the life of the donor.

52. The method according to claim 51, further comprising the step of:
receiving from the nonprofit entity an assignment of a right to determine whether to renew the term life insurance policy.

53. The method according to claim 18, wherein the assignment receiving step includes the step of:
receiving from the nonprofit entity the assignment of the death benefit of a variable life insurance policy held by the nonprofit entity on the life of the donor.

54. The method according to claim 53, further comprising the step of:
receiving from the nonprofit entity an assignment of a right to direct investment of a reserve fund of the variable life insurance policy.

55. The method according to claim 54, further comprising the step of:
depositing the reserve fund in at least one segregated account.

56. The method according to claim 55, further comprising the step of:
investing at least some of the reserve fund to a hedge fund.

57. The method according to claim 55, further comprising the step of:
investing at least some of the reserve fund to a mutual fund.

58. The method according to claim 55, further comprising the step of:
investing at least some of the reserve fund in a stock portfolio.

59. The method according to claim 55, further comprising the step of:
investing at least some of the reserve fund in a money market fund.

60. The method according to claim 18, further comprising the step of:
determining a required return on investments including the life insurance policy and the annuity.

61. The method according to claim 18, wherein the assignment receiving step includes the step of:
receiving from the nonprofit entity the assignment of the death benefit of the life insurance policy held by the nonprofit entity on the life of a selected donor.

62. The method according to claim 61, further comprising the step of:
selecting at least one donor as a function of at least one underwriting characteristic of each prospective donor in a set including at least one prospective donor.

63. The method according to claim 61, further comprising the step of:
selecting at least one donor from a prospective donor set including at least one prospective donor, as a function of at least one characteristic of each of the at least one prospective donor.

64. The method according to claim 63, wherein the selecting step includes the step of:
selecting donors from a database storing information related to the at least one characteristic of each prospective donor in the prospective donor set, the at least one characteristic including at least one of an age, sex, occupation, employment status, health status, household income, net worth, country of origin, current location of residence, donative desire, donative intent, and current amount of insurance held by the prospective donor.

65. The method according to claim 63, further comprising the step of:
generating a prospective donor set including at least one prospective donor.

66. The method according to claim 65, wherein the generating step includes the step of:
searching an alumni database for prospective donors.

67. The method according to claim 66, wherein the searching step includes the step of:
searching the alumni database by graduating year of the alumni of one of a university and a college.

68. The method according to claim 67, further comprising the step of:
selecting one of a university and a college as the nonprofit entity.

69. The method according to claim 18, further comprising the step of:
obtaining consent from the donor for the nonprofit entity to obtain the life insurance policy on the life of the donor.

70. The method according to claim 69, wherein the obtaining step includes the step of:
obtaining consent from the donor for the nonprofit entity to obtain term life insurance on the life of the donor.

71. The method according to claim 69, wherein the obtaining step includes the step of:
obtaining consent from the donor for the nonprofit entity to obtain universal life insurance on the life of the donor.

72. The method according to claim 69, wherein the obtaining step includes the step of:
obtaining consent from the donor for the nonprofit entity to obtain variable life insurance on the life of the donor.

73. The method according to claim 18, wherein the allocating step includes the step of:
allocating the first portion of the distribution to the nonprofit entity selected by the donor.

74. The method according to claim 18, wherein the allocating step includes the step of:
allocating the first portion of the distribution to the nonprofit entity for a charitable cause selected by the donor.

75. The method according to claim 18, further comprising the step of:
generating a select donor list, the select donor list including the at least one donor.

76. The method according to claim 75, further comprising the step of:
providing the select donor list to an insurance agent.

77. The method according to claim 75, further comprising the step of:
processing life insurance applications on each select donor in the select donor list.

78. The method according to claim 77, wherein the processing step includes the step of:
obtaining information from each select donor necessary to complete the life insurance application for the select donor.

79. The method according to claim 77, wherein the processing step includes the step of:
selecting a type of life insurance policy for each select donor, wherein the type of life insurance policy includes one of a universal life insurance policy, a whole life insurance policy, a variable universal life insurance policy and a term life insurance policy.

80. The method according to claim 77, wherein the processing step includes the step of:
selecting a universal life insurance policy as the life insurance policy.

81. The method according to claim 77, further comprising the step of:
submitting a life insurance application on each select donor in the select donor list.

82. The method according to claim 77, further comprising the step of:
selecting a life insurance company to provide life insurance for a select donor as a function of at least one criterion of the life insurance company.

83. The method according to claim 82, wherein the step of selecting the life insurance company includes the step of:
selecting the life insurance company as a function of at least one of a credit rating of the life insurance company, and a premium and a death benefit of a life insurance policy offered by the life insurance company for the select donor.

84. The method according to claim 82, wherein the step of selecting the life insurance company includes the step of:
selecting the life insurance company from a plurality of life insurance companies.

85. The method according to claim 18, further comprising the step of:
selecting an optimal policy as the life insurance policy for the donor as a function of at least one variable relevant to an overall economic performance of the life insurance policy.

86. The method according to claim 85, further comprising the step of:
determining an expected internal rate of return on the death benefit of the life insurance policy, as an indication of the overall economic performance of the life insurance policy.

87. The method according to claim 18, further comprising the step of:
maintaining the life insurance policy in force.

88. The method according to claim 87, wherein the maintaining step includes the step of:
paying periodic premiums on the life insurance policy with investment capital from an investor.

89. The method according to claim 88, wherein the establishing step includes the step of:
determining a required return on the investment capital.

90. A method for a nonprofit entity to facilitate donations, comprising the steps of:
assigning a death benefit of a life insurance policy to a financial benefactor, the life insurance policy insuring a life of a donor;
assigning an opportunity to maintain the life insurance policy to the financial benefactor, the financial benefactor receiving financing, a total financing of the financial benefactor including the received financing, the financial benefactor allocating at least some of the total financing to maintain the life insurance policy;
receiving a right to a first portion of the distribution by the financial benefactor from assets of the financial benefactor including a value of the death benefit of the life insurance policy.

91. The method according to claim 90, wherein the receiving step includes the step of:
receiving the right to the first portion of the distribution by the financial benefactor from assets of the financial benefactor including a cash value of the life insurance policy and an annuity, the annuity being purchased by the financial benefactor with another portion of the total financing to provide annuity payments to the financial benefactor for the life of the donor.

92. The method according to claim 91, wherein the step of assigning the opportunity to maintain the life insurance policy includes the step of:
assigning the opportunity to maintain the life insurance policy to the financial benefactor, the financial benefactor acquiring debt financing to maintain the life insurance policy at an interest rate lower than a credit rate on the life insurance policy.

93. The method according to claim 91, wherein the step of receiving the right to the first portion of the distribution by the financial benefactor from assets of the financial benefactor including the cash value of the life insurance policy and the annuity, includes the step of:
receiving a right to a first portion of the annuity payments to the financial benefactor.

94. The method according to claim 93, wherein the step of receiving the right of the first portion of the annuity payments to the financial benefactor includes the step of:
receiving the right of the first portion of the annuity payments to the financial benefactor, the financial benefactor using equity financing to purchase the annuity on the life of the donor.

95. The method according to claim 94, wherein the step of receiving the right of the first portion of the annuity payments to the financial benefactor, includes the step of:
receiving the right of the first portion of the annuity payments to the financial benefactor, a second portion of the annuity payments being allocated by the financial benefactor as payments on the equity financing used to purchase the annuity, and a third portion of the annuity payments being allocated by the financial benefactor as payments on the debt financing used to maintain the life insurance policy.

96. The method according to claim 95, wherein the step of assigning the death benefit includes the step of:
assigning the death benefit of the life insurance policy to the financial benefactor, the financial benefactor allocating a first portion of the death benefit as payment on the equity financing used to purchase the annuity, and a second portion of the death benefit as payment on the debt financing used to maintain the life insurance policy.

97. The method according to claim 93, wherein the step of receiving the right to the first portion of the annuity payments to the financial benefactor includes the step of:
receiving an ownership interest in the financial benefactor, the ownership interest including an entitlement to first portion of the annuity payments.

98. The method according to claim 97, wherein the ownership interest receiving step includes the step of:
receiving an interest as a partner in a partnership, the partnership being the financial benefactor.

99. The method according to claim 97, wherein the ownership interest receiving step includes the step of:
receiving an ownership interest in a limited liability corporation, the limited liability corporation being the financial benefactor.

100. The method according to claim 90, further comprising the step of:
obtaining consent from the donor to hold a universal life insurance policy on the life of the donor.

101. The method according to claim 90, further comprising the step of:
obtaining consent from the donor to hold a term life insurance policy on the life of the donor.

102. The method according to claim 101, further comprising the step of:
assigning to the financial benefactor a right to determine whether to renew the term life insurance policy.

103. The method according to claim 90, further comprising the step of:
obtaining consent from the donor to hold a variable life insurance policy on the life of the donor.

104. The method according to clam 103, further comprising the step of:
assigning to the financial benefactor a right to direct investment of a reserve fund of the variable life insurance policy.

105. A method for a party with an insurable interest in a life insurance policy to enable donations to a nonprofit entity, comprising the step of:
donating the life insurance policy to the nonprofit entity, the nonprofit entity assigning a death benefit of the life insurance policy to a financial benefactor in exchange for a right to a first portion of a distribution from assets of the financial benefactor, the assets including a cash value of the life insurance policy, the financial benefactor receiving an opportunity to maintain the life insurance policy, the financial benefactor receiving financing, a total financing of the financial benefactor including the received financing, a portion of the total financing being allocated to maintain the life insurance policy for the nonprofit entity.

106. The method according to claim 105, further comprising the step of:
selecting a charitable cause to receive at least some of the first portion of the distribution provided by the financial benefactor to the nonprofit entity.

107. The method according to claim 106, wherein the selecting step includes the step of:
acquiring a donor card from the financial benefactor, the donor card storing information relating to a balance of the first portion of the distribution and other distributions provided by the financial benefactor to the nonprofit entity and information relating to selected charitable causes.

108. The method according to claim 105, further comprising the step of:
receiving another insurance product from an insurance carrier, the insurance product being at least partially subsidized by the financial benefactor.

109. The method according to claim 108, wherein the insurance product receiving step includes the step of:
receiving a long term care insurance policy from an insurance carrier, the financial benefactor financing the long term care insurance policy.

110. The method according to claim 105, wherein the donating step includes the step of:
donating the life insurance policy to the nonprofit entity, the nonprofit entity assigning the death benefit of the life insurance policy and the opportunity to maintain the life insurance policy to a financial benefactor in exchange for a right to a first portion of annuity payments from the financial benefactor, the financial benefactor purchasing an annuity to provide annuity payments for the insured life in the life insurance policy.

111. The method according to claim 105, wherein the donating step includes the step of:
donating the life insurance policy to the nonprofit entity, the nonprofit entity assigning the death benefit of the life insurance policy and the opportunity to maintain the life insurance policy to a financial benefactor in exchange for an ownership interest in the financial benefactor, the ownership interest including an entitlement to a first portion of annuity payments from the financial benefactor, the financial benefactor purchasing an annuity to provide annuity payments for the insured life in the life insurance policy.

112. The method according to claim 105, wherein the donating step includes the step of:
donating a universal life insurance policy to the nonprofit entity.

113. The method according to claim 105, wherein the donating step includes the step of:
donating a variable life insurance policy to the nonprofit entity.

114. The method according to claim 105, wherein the donating step includes the step of:
donating a term life insurance policy to the nonprofit entity.

115. A method for a party with an insurable interest in a life insurance policy to enable donations to a nonprofit entity, comprising the step of:
providing consent to a nonprofit entity to obtain the life insurance policy, the nonprofit entity assigning a death benefit of the life insurance policy to a financial benefactor in exchange for a right to a first portion of a distribution from assets of the financial benefactor, the assets including a cash value of the life insurance policy, the financial benefactor receiving an opportunity to maintain the life insurance policy, the financial benefactor receiving financing, a total financing of the financial benefactor including the received financing, a portion of the total financing being allocated to maintain the life insurance policy.

116. A method for facilitating donations to a nonprofit entity, comprising the steps of:
providing financing to a financial benefactor of the nonprofit entity, at least part of the provided financing being applied to at least one of maintaining an insurance policy in force, and purchasing an annuity; and
receiving a right to a respective portion of a distribution from assets of the financial benefactor including a cash value of the life insurance policy and the annuity,
wherein the life insurance policy, insuring a life of a donor, is held by the nonprofit entity, the nonprofit entity assigning a death benefit on the life insurance policy to the financial benefactor in exchange for a right to a respective portion of the distribution, and
wherein the financial benefactor purchases the annuity on the life of the donor to provide annuity payments to the financial benefactor for the life of the donor, and
wherein the financial benefactor has an opportunity to maintain the life insurance policy.

117. The method according to claim 116, wherein the respective right receiving step includes the step of:
receiving a respective ownership interest in the financial benefactor, the respective ownership interest including an entitlement to the respective portion of the distribution.

118. The method according to claim 116, wherein the providing step includes the step of:
investing an amount in the financial benefactor, at least part of the invested amount being used by the financial benefactor to purchase the annuity.

119. The method according to claim 118, wherein the investing step includes the step of:
investing the amount in the financial benefactor, the invested amount being used in part by the financial benefactor to purchase the annuity, the financial benefactor maintaining the life insurance policy with other financing.

120. The method according to claim 118, further comprising the step of:
receiving a right to a respective portion of the death benefit of the life insurance policy.

121. The method according to claim 119, further comprising the step of:
earning a return on the invested amount as a function of the respective portion of the distribution and the respective portion of the death benefit received from the financial benefactor.

122. The method according to 118, further comprising the step of:
accepting equity investments to provide the invested amount to the financial benefactor.

123. The method according to claim 116, wherein the providing step includes the step of:
investing an amount in the financial benefactor, at least part of the invested amount being used by the financial benefactor to maintain the life insurance policy.

124. The method according to claim 116, further comprising the step of:
accepting debt financing to provide the invested amount to the financial benefactor.

125. The method according to claim 116, wherein the providing step includes the step of:
providing debt financing to the financial benefactor for the maintenance of the life insurance policy at a rate lower than a crediting rate on a cash value of the life insurance policy.

126. A method of facilitating donations to a nonprofit entity comprising the steps of:
issuing a life insurance policy on a life of a consenting donor to a nonprofit entity, the nonprofit entity assigning a death benefit of the life insurance policy to a financial benefactor in exchange for an interest in a portion of a distribution from assets of the financial benefactor, the assets including a cash value of a life insurance policy and an annuity purchased by the financial benefactor to provide annuity payments to the financial benefactor for the life of the donor; and
receiving premium payments on the life insurance policy from the financial benefactor.

127. The method according to claim 126, further comprising the step of:
paying the death benefit of the life insurance policy to the financial benefactor upon a death of the donor, the financial benefactor allocating portions of the death benefit to sources of funding provided to the financial benefactor for the premium payments on the life insurance policy and for the purchase of the annuity.

128. The method according to claim 126, wherein the issuing step includes the step of:
issuing a universal life insurance policy to the nonprofit entity.

129. The method according to claim 126, wherein the issuing step includes the step of:
issuing a term life insurance policy to the nonprofit entity.

130. The method according to claim 129, further comprising the step of:
renewing the term life insurance policy for another term as directed by the financial benefactor.

131. The method according to claim 126, wherein the issuing step includes the step of:
issuing a variable life insurance policy to the nonprofit entity.

132. The method according to claim 131, further comprising the step of:
depositing a reserve fund on the variable life insurance policy to a segregated account as directed by the financial benefactor.

133. A method of facilitating donations to a nonprofit entity comprising the steps of:
issuing a life insurance policy to a donor on a life of the donor, the donor donating the life insurance policy to a nonprofit entity, the nonprofit entity assigning a death benefit of the life insurance policy to a financial benefactor in exchange for an interest in a portion of a distribution from assets of the financial benefactor, the assets including a cash value of a life insurance policy and an annuity purchased by the financial benefactor to provide annuity payments to the financial benefactor for the life of the donor; and
receiving premium payments on the life insurance policy from the financial benefactor.

134. A method of facilitating donations to a nonprofit entity comprising the step of:
selling an annuity to a financial benefactor of a nonprofit entity, the nonprofit entity holding a life insurance policy on a life of a donor, and assigning a death benefit to the financial benefactor, the financial benefactor maintaining the life insurance policy and purchasing the annuity to provide the financial benefactor with annuity payments for the life of the donor, the financial benefactor distributing a first portion of the annuity payments to the nonprofit entity and other portions of the annuity payments as payments on financing provided to the nonprofit entity for the maintenance of the life insurance policy and the purchase of the annuity.

135. A method of facilitating donations to a nonprofit entity comprising the steps of:
lending an amount to another entity, the lent amount being invested by the other entity in a financial benefactor of a nonprofit entity, the financial benefactor using the invested lent amount to maintain a life insurance policy held by the nonprofit entity on a life of a donor, the nonprofit entity assigning a death benefit of the life insurance policy to the financial benefactor in exchange for a right to a first portion of annuity payments from the financial benefactor, the financial benefactor purchasing an annuity to provide the annuity payments for the life of the donor with other invested funds and providing a second portion of the annuity payments as payments on the other invested funds; and
receiving payments from the other entity, the other entity funding the payments with a third portion of the annuity payments provided by the financial benefactor to the other entity.

136. The method according to claim 135, further comprising the step of:
accepting the annuity as collateral on a loan lending the lent amount to the other entity.

137. The method according to claim 135, wherein the lending step includes the step of:
lending the amount to the other entity at a rate lower than a credit rate of a cash value of the life insurance policy.

138. A vehicle for facilitating donations to a nonprofit entity, the vehicle comprising:
an instrument for providing consent of a donor to a life insurance carrier to issue a life insurance policy on a life of the donor to a nonprofit entity, the nonprofit entity assigning a death benefit on the life insurance policy to a financial benefactor in exchange for a portion of a distribution from assets of the financial benefactor, the assets of the financial benefactor including a cash value of the life insurance policy and an annuity purchased by the financial benefactor providing annuity payments to the financial benefactor for the life of the donor.

139. The vehicle according to claim 138, further comprising:
an instrument for providing consent of a donor to an annuity carrier to sell the annuity to the other entity to provide the other entity with the annuity payments for the life of the donor.

140. An instrument for facilitating donations to a nonprofit entity, the instrument comprising:
a life insurance policy on a life of a donor, wherein the nonprofit entity is the owner of the life insurance policy, the nonprofit entity assigning a death benefit of the life insurance policy to a financial benefactor of the nonprofit entity, the financial benefactor maintaining the life insurance policy and purchasing an annuity on the life of the donor to provide the financial benefactor with annuity payments for the life of the donor, the financial benefactor providing a first portion of the annuity payments to the nonprofit entity.

141. An investment vehicle in a financial benefactor of a nonprofit entity, the investment vehicle comprising:
a tradable instrument providing investment capital to the financial benefactor, the financial benefactor maintaining a life insurance policy held by the nonprofit entity on a life of a donor with a portion of a total financing of the financial benefactor, the total financing including the investment capital,
wherein the nonprofit entity assigns a death benefit of the life insurance policy to the financial benefactor in exchange for a right to a first portion of annuity payments from the financial benefactor, the financial benefactor purchasing an annuity with another portion of the total financing to provide the annuity payments to the financial benefactor for the life of the donor.

142. An instrument for facilitating donations to a nonprofit entity, comprising:
an annuity providing annuity payments to a financial benefactor of the nonprofit entity for a life of a donor, the financial benefactor allocating a portion of the annuity payments to the nonprofit entity in exchange for a death benefit of the life insurance policy, the financial benefactor maintaining the life insurance policy for the nonprofit entity.

143. An instrument for facilitating donations to a nonprofit entity, comprising:
an insured annuity, wherein the insured annuity includes:
a life insurance policy insuring at least one insured benefactor, and
an annuity providing annuity payments for a period of time, the period of time being a measured life of at least one of the at least one insured benefactor,
wherein the life insurance policy is owned by the nonprofit entity, the nonprofit entity assigning at least a portion of a death benefit of the policy to a nonprofit development partner, the nonprofit development partner maintaining the life insurance policy with financing arising from debt financing provided by a bank to one of a preferred investor in the nonprofit development partner, the nonprofit development partner and the nonprofit entity,
wherein the annuity is purchased by one of the nonprofit development partner and an equity investor with financing arising from equity financing provided by the equity investor, and
wherein the insured annuity provides the nonprofit entity with consideration in exchange for the assignment of the portion of the death benefit of the policy to the nonprofit development partner.

144. The instrument according to claim 143, wherein terms of the life insurance policy meet one of Cash Value Accumulation Test and Guideline Premium Test requirements for an instrument to qualify as a life insurance policy under the Internal Revenue Code.

145. The instrument according to claim 144, wherein a ratio of the death benefit to a cash value of the life insurance policy one of meets and exceeds a minimum ratio required for a life insurance policy under the Cash Value Accumulation Test.

146. The instrument according to claim 145, wherein the debt financing is provided on a more favorable basis as a result of an application of the Cash Value Accumulation Test.

147. A debt investment vehicle to facilitate donations to a nonprofit entity, the debt investment vehicle comprising:
a loan to an investor, the investor investing a principle of the loan in a financial benefactor of the nonprofit entity, the financial benefactor using the loan to maintain a life insurance policy held by the nonprofit entity on a life of a donor,
wherein the financial benefactor purchases an annuity to provide annuity payments for the life of the donor with other invested funds,
wherein the nonprofit entity assigns a death benefit of the life insurance policy to the financial benefactor in exchange for a first portion of annuity payments from the financial benefactor, and
wherein the financial benefactor allocates a second portion of the annuity payments for payments on the loan, and a third portion of the annuity payments as payments on the other invested funds used to purchase the annuity.

148. A method of facilitating donations to a nonprofit entity, the method comprising the step of:
forming an entity to be the financial benefactor of the nonprofit entity,
wherein the entity:
accepts an assignment of a death benefit of the life insurance policy from the nonprofit entity,
accepts invested capital from at least one primary investor for maintaining the life insurance policy,
accepts invested capital from at least one secondary investor for purchasing an annuity to provide the entity with annuity payments for the life of the donor,
grants an ownership interest to each of the nonprofit entity, the at least one primary investor and the at least one secondary investor, each ownership interest entitling a respective holder of the interest to a portion of a distribution from assets of the entity, the assets of the entity including a cash value of the life insurance policy and the annuity payments.

149. A system enabling donations to a nonprofit entity, comprising:
a donor;
a nonprofit entity holding a life insurance policy on a life of a donor; and
a financial benefactor to the nonprofit entity, the financial benefactor having an annuity providing annuity payments on the life of the donor, the financial benefactor maintaining the life insurance policy and having a right to a death benefit of the life insurance policy, the financial benefactor providing the nonprofit entity with a first portion of the annuity payments.

150. An investment vehicle for facilitating donations to a nonprofit entity, comprising:
a bond, the bond entitling a bearer of the bond with a right to a coupon payment and a repayment of a principal amount of the bond from a financial benefactor of the nonprofit entity,
wherein the nonprofit entity holds a life insurance policy on a life of a donor, the nonprofit entity assigning a death benefit of the life insurance policy to the financial benefactor,
wherein the financial benefactor maintains the life insurance policy and purchases an annuity providing the financial benefactor with annuity payments for the life of the donor, the financial benefactor providing periodic payments to the nonprofit entity backed by a first portion of distributions from assets including a cash value of the life insurance policy and the annuity, and
wherein the coupon payments are backed by a second portion of the distributions by the financial benefactor, and the repayment of the principal amount of the bond is backed by a portion of the death benefit provided to the financial benefactor.

151. A method for enabling donations to a nonprofit entity, comprising the steps of:
receiving an assignment from the nonprofit entity of a death benefit of a life insurance policy held by the nonprofit entity, the life insurance policy insuring a life of a donor;
receiving an opportunity to maintain the life insurance policy;
receiving financing arising from debt financing, at least some of the received financing being allocated for maintaining the life insurance policy;
receiving a loan guaranty from an equity investor for the debt financing, the loan guaranty being a collateral assignment in charitable gift annuity payments received by the equity investor from the nonprofit entity, the equity investor purchasing a charitable gift annuity from the nonprofit entity, the nonprofit entity financing the charitable gift annuity payments on the charitable gift annuity with a portion of a commercial annuity purchased by the nonprofit entity from an annuity carrier, the nonprofit entity retaining a difference between the commercial annuity payments and the charitable gift annuity payments;
providing consideration to the equity investor for the loan guaranty; and
providing the nonprofit entity with a right to a first portion of a distribution from assets, the assets including a value of the death benefit of the life insurance policy.

152. A method for facilitating donations to a nonprofit entity, comprising the steps of:
purchasing a charitable gift annuity from the nonprofit entity to receive charitable gift annuity payments from the nonprofit entity on a measured life of at least one insured benefactor to the nonprofit entity;
offering a loan guaranty on debt financing provided to at least one of a nonprofit development partner of the nonprofit entity, a preferred equity investor in the nonprofit development partner, and a bank providing the debt financing to at least one of the preferred equity investor, the nonprofit development partner and the nonprofit entity; and
receiving consideration for the loan guaranty from at least one of the nonprofit entity, the nonprofit development partner, the preferred equity investor and the bank,
wherein the nonprofit entity funds the charitable gift annuity payments with a portion of commercial annuity payments from a commercial annuity purchased by the nonprofit entity from an annuity carrier,
wherein the nonprofit entity owns a life insurance policy insuring a life of the at least one insured benefactor, the nonprofit entity assigning a death benefit under the life insurance policy to the nonprofit development partner, and
wherein the debt financing is used to generate funding used by the nonprofit development partner to maintain the life insurance policy, and
wherein the loan guaranty includes a collateral assignment to one of the nonprofit entity, the nonprofit development partner, the preferred equity investor and the bank in the charitable gift annuity payments.
